(19) United States
(12) Patent Application Publication
(10) Pub. No.: US 2026/0120246 A1
(43) Pub. Date: Apr. 30, 2026

(54) METHOD AND SYSTEM FOR DETERMINING AUTO-EXPOSURE FOR HIGH-DYNAMIC RANGE OBJECT DETECTION USING NEURAL NETWORK

(71) Applicant: TORC CND ROBOTICS, INC., Montreal (CA)

(72) Inventors: Emmanuel Luc Julien Onzon, Munich (DE); Felix Heide, Palo Alto, CA (US); Fahim Mannan, Montreal (CA)

(21) Appl. No.: 19/373,298

(22) Filed: Oct. 29, 2025

Related U.S. Application Data
(63) Continuation of application No. 17/722,261, filed on Apr. 15, 2022, now Pat. No. 12,482,068.
Application No. 17/722,261 is a continuation-in-part of application No. 17/712,727, filed on Apr. 4, 2022, now Pat. No. 11,783,231.
Application No. 17/712,727 is a continuation of application No. 16/927,741, filed on Jul. 13, 2020, now Pat. No. 11,295,176.
(60) Provisional application No. 63/175,505, filed on Apr. 15, 2021.

(51) Int. Cl. G06T 5/50; G06F 18/241; G06F 18/2413; G06N 3/045; G06N 3/084; G06N 20/00; G06T 5/60; G06T 5/73; G06V 10/44

(52) U.S. Cl. CPC G06T 5/50; G06F 18/241; G06F 18/24133; G06N 3/045; G06N 3/084; G06N 20/00; G06T 5/60; G06T 5/73; G06V 10/454; G06T 2207/20081; G06T 2207/20084; G06T 2207/20182

(57) ABSTRACT

An auto-exposure control is proposed for high dynamic range images, along with a neural network for exposure selection that is trained jointly, end-to-end with an object detector and an image signal processing (ISP) pipeline. Corresponding method and system for high dynamic range object detection are also provided.

### CROSS REFERENCE TO RELATED APPLICATIONS

The present application is a continuation of U.S. patent application Ser. No. 17/722,261 filed on Apr. 15, 2022 (ALX-009-US), which claims benefit from U.S. provisional patent application Ser. No. 63/175,505, filed on Apr. 15, 2021 (ALX-009-US-prov). ALX-009-US is also a continuation-in-part of U.S. patent application Ser. No. 17/712,727 filed on Apr. 4, 2022, which is now U.S. Pat. No. 11,783,231 issued on Oct. 10, 2023 (ALX-004-US-CON2). ALX-004-US-CON2 is a continuation of U.S. patent application Ser. No. 16/927,741 filed on Jul. 13, 2020, which is now U.S. Pat. No. 11,295,176 issued on Apr. 5, 2022 (ALX-004-US-CON1). ALX-004-US-CON1 is a continuation of U.S. patent application Ser. No. 16/025,776 filed on Jul. 2, 2018, which is now a U.S. Pat. No. 10,713,537 issued on Jul. 14, 2020 (ALX-004-US). ALX-004-US claims benefit from U.S. provisional patent application Ser. No. 62/528,054 filed on Jul. 1, 2017 (ALX-004-US-prov).

The entire contents of above noted patents and applications are incorporated herein by reference.

### FIELD OF THE INVENTION

The present invention relates to a system and method for an auto-exposure selection and control employing a neural network, and in particular for determining the auto-exposure for high-dynamic range object detection.

### BACKGROUND OF THE INVENTION

Computer vision systems have to measure and analyze a wide range of luminances, from no ambient illumination at night to a bright sunny day, which may exceed 280 dB expressed as a ratio of the highest to the lowest luminance values.

While a typical range of luminance for an ordinary outdoor scene is about 120 dB, there are numerous situations when this range may be much wider. For example, exiting a tunnel may include various scene regions with almost no ambient illumination, the Sun, and scene points with intermediate luminances, all in one image. Capturing this wide dynamic range of luminances has been an open challenge for image sensors, with today's conventional CMOS image sensors being capable of acquiring only about 60-70 dB in a single capture.

This constraint of existing image sensors poses a fundamental problem for low-level and high-level vision tasks in uncontrolled scenarios, and for various industrial applications that make decisions relying on computer vision modules in-the-wild, including outdoor robotics, drones, self-driving vehicles, driver assistance systems, navigation, and remote sensing, to name a few.

To overcome this limitation, prior art vision pipelines rely on high dynamic range (HDR) sensors that acquire multiple captures with different exposures of the same scene. Numerous prior art explores different HDR sensor designs and acquisition strategies, with sequential capture methods and sensors that split each pixel into two sub-pixels being the most successfully deployed HDR sensor architectures.

Although modern HDR image sensors are capable of capturing up to 140 dB at moderate resolutions, e.g., OnSemi™ AR0820AT image sensor, a multi-capture acquisition approach comes with fundamental limitations. Because exposures have different duration or start at different times, capturing a dynamic scene results in motion artefacts, which need to be eliminated. Also custom sensor architectures come at the cost of reduced fill-factor, and hence resolution, and also higher production cost, compared to conventional intensity sensors. Moreover, capturing HDR images not only requires a sensor that can measure the scene but also necessitates a high quality optics for HDR acquisition, without glare and lens flare.

High Dynamic Range Imaging. As existing sensors are not capable of capturing an entire dynamic range of luminance values in real-world scenes in a single shot, HDR imaging methods employ multiplexing strategies to recover this dynamic range from multiple measurements with different exposures. For static scenes, conventional HDR acquisition methods rely on temporal multiplexing by sequentially capturing low dynamic range (LDR) images, also to be referred to as standard dynamic range (SDR) images in this application, for different exposures and then combining them by exposure bracketing. These methods suffer from motion artefacts for dynamic scenes, with a large volume of prior art being focused on post-capture stitching, optical flow, and deep learning. While these methods are successful for photography, they are not suitable for real-time applications, for example robotics. For safety-critical applications, including autonomous driving, recent prior art work that hallucinates HDR content from LDR images is also not an alternative for detection and navigation stacks that must measure a real world.

Adaptive Camera Control. Although an auto-exposure control, or exposure control, is fundamental to acquisition of images using conventional low dynamic range sensors, especially when employed in dynamic outdoor environments, existing exposure control software (and auto-white balance control) has been largely limited to proprietary algorithms. This is because the feedback of exposure control algorithms must exceed real-time capture rates, and as a result, exposure control algorithms are often implemented in hardware on the sensor or as part of the hardware image signal processing (ISP) pipeline. Existing classical algorithms pose optimal exposure selection as an optimal control problem on image statistics, or rely on efficient heuristics. Another prior art approach solves a model-predictive control problem to predict optimal exposure values. Recently, a number of prior art has suggested to select exposure values to optimize local image gradients. Nevertheless, determining the auto-exposure for various computer vision tasks still remains a challenge.

Post-Capture Tonemapping. Numerous prior art has explored tonal adjustments to high-dynamic range or low-dynamic range images after the capture process, driven by scene semantics. Recent tone-mapping approaches rely on deep convolutional neural networks to perform tonal and exposure-adjustments post-capture. While these approaches are capable of compressing the dynamic range after capture, they cannot recover details that are lost during the capture process, including saturated and low-light flux-limited regions.

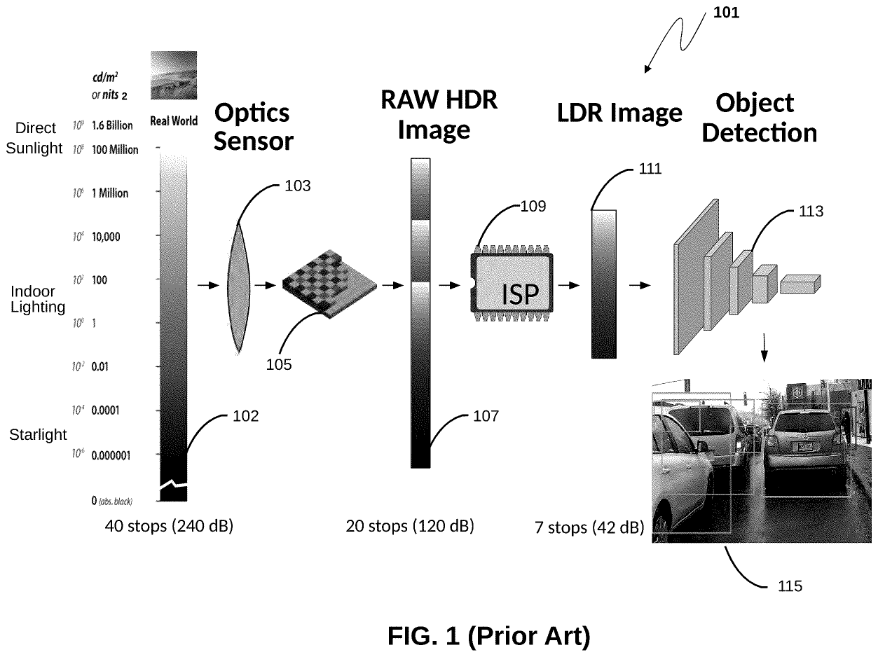

An example of the prior art arrangement 101, using HDR imaging in a computer vision pipeline, is shown in FIG. 1. A range of luminances in the real world scene is captured at step 102, the range of luminances not being a raw image yet. This range of luminances may span a dynamic range as high as 240 dB, or “40 stops”, where one stop up corresponds to a doubling of the amount of light, i.e., 6 dB. In FIG. 1, the range of luminances is shown to be captured at 40 stops (240 dB) for a variety of light exposures, ranging from starlight (10-6 cd/m2) to direct sunlight (109 cd/m2). The light, which is not yet an image, is then passed through an optics sensor or lens 103, followed by being collected by an HDR image sensor 105. At the image sensor 105, a raw HDR image 107 is digitized and recorded. There are several types of pixels on the HDR image sensor 105, namely some pixels would record high amount of light, other pixels intermediate amount of light and yet other pixels low amount of lights; or several images are recorded by the same pixels but with different exposure times, or a combination of both. As a result, the HDR image sensor 105 first records a set of low dynamic range (LDR) images (not shown in FIG. 1), each capturing a subset of the entire dynamic range, which is typically about 120 dB. At this step, a fusion of the different LDR images into a single HDR image typically takes place on the sensor, in addition to the recording of these LDR Images. However, this is optional, and an image signal processor (ISP) 109 could perform this step instead. For example, the HDR image 107 may be produced at 20 stops (120 dB), after which the ISP 109 transforms the HDR image 107 into a LDR image 111 at 7 stops (42 dB), after which an object detection 113 is performed to achieve final detection results 115, for example providing respective coordinates and classes for objects to be identified. One way of visualizing results is to show overlaid boxes containing objects of interest.

Therefore there is a need in industry for developing a computer vision system with improved characteristics, which would overcome or mitigate deficiencies of the prior art.

### SUMMARY OF THE INVENTION

There is an object of the present invention to provide a method and system for an improved exposure and/or auto-exposure control and selection for high-dynamic range object detection.

The present invention proposes a neural auto-exposure network that predicts exposure values optimal for a downstream object detection task. This control network and the downstream detector have been trained in an end-to-end fashion jointly with a differentiable image processing pipeline, which transfers the RAW sensor measurements to red, green blue (RGB) images ingested by the object detector model. The training of this end-to-end model is challenging as an auto-exposure (AE) control dynamically modifies the RAW sensor measurement. Instead of an online training approach which would require camera and annotation in-the-loop, the proposed system is trained by simulating the image formation model of a low-dynamic range sensor from input HDR captures. To this end, a novel HDR image dataset is acquired, for example, for automotive object detection. The proposed method is validated by computer simulation and using an experimental vehicle prototype that evaluates detection scores for fully independent camera systems with different auto-exposure control (AEC) methods placed side-by-side and separately annotating ground truth labels. The proposed method outperforms conventional auto-exposure methods by 5.7 mAP across diverse automotive scenarios.

In particular the embodiments of the present invention:
Introduces a synthetic image formation model in the training mode, where LDR images are derived/simulated from captured HDR images;
Proposes a training procedure for the proposed auto-exposure network that relies on the synthetic LDR image formation model;
Introduces a neural network architecture, which predicts exposure values driven by an object detection downstream network in real time and based on the results of the training procedure;
Validates the proposed method by computer simulation and by an experimental prototype, and demonstrates that the proposed neural autoexposure control method outperforms prior art autoexposure methods for automotive object detection across all tested scenarios.

According to one aspect of the invention, there is provided a method for determining an auto-exposure value of a low dynamic range (LDR) sensor for use in high dynamic range (HDR) object detection, the method comprising:
employing at least one hardware processor for:
   forming an auto-exposure neural network for predicting exposure values for the LDR sensor driven by a downstream object detection neural network in real time;
   training the auto-exposure neural network jointly, end-to-end together with the object detection neural network and an image signal processing (ISP) pipeline, thereby yielding a trained auto-exposure neural network; and
   using the trained auto-exposure neural network to generate an optimal exposure value for the LDR sensor and the downstream object detection neural network for the HDR object detection.

In the method described above, the forming comprises forming a Global Image Feature neural network, or a Semantic Feature neural network, or a Hybrid neural network, comprising both the Global Image Feature neural network and the Semantic Feature neural network.

The method further comprises, prior to the training, forming a training dataset of images, comprising:
capturing a set of HDR images by a HDR sensor in real life environment;
for each HDR image from the set of HDR images, forming a corresponding linear HDR image;
thereby forming the training dataset.

Alternatively, the method may comprise, prior to the training, forming a training dataset of images as follows: by a HDR sensor, for each HDR image captured in real life environment, outputting “n” linear LDR images with different exposures selected so that a combined dynamic range of the “n” linear LDR images covers a dynamic range of said each HDR image.

In the method described above, the forming the training dataset further comprises fusing the “n” linear LDR images into a corresponding linear HDR image I_{hdr}, the fusing further comprising taking into account weighted average of pixel values across “n” LDR images with weight equal to the inverse of the noise variance.

In the method described above, the training further comprises simulating a simulated raw LDR image from the linear HDR image, and using the simulated raw LDR image for the training of the auto-exposure neural network.

In the method described above, per each training operation, the training comprises simulating a first and second simulated raw LDR images derived from respective first and second linear HDR images and corresponding to two consecutive or closely following frames;
training the first simulated raw LDR image with a random exposure shift; and
training the second simulated LDR image with an exposure value predicted by the auto-exposure neural network based on the training of the first simulated raw image.

In the method described above, the simulating further comprises scaling and quantization of the linear HDR image, followed by optionally clamping the linear HDR image.

In the method described above, the simulating further comprises simulating a radiant power per pixel φₛᵢₘ for the simulated raw LDR image as a Bayer pattern sampling of the linear HDR image I_{hdr}.

In the method described above, the simulating further comprises adding noise to the simulated raw LDR image to mimic a noise distribution of the LDR sensor.

In the method described above, the forming the global image feature neural network comprises generating histograms from a raw LDR image captured by the LDR sensor at a number of different scales, including a coarse histogram for an entire raw LDR image, and respective finer histograms for corresponding smaller sections of the raw LDR image.

In the method described above, the generating histograms comprises generating histograms from one of the following:
green pixels values of the raw LDR image;
luminance pixel values of the raw LDR image;
red pixels values of the raw LDR image;
blue pixels values of the raw LDR image.

The method described above further comprises performing one-dimensional convolution operations of the histograms, followed by dense layer operations on the results of convolution operations.

In the method described above, the forming the semantic feature neural network further comprises: using an output from a feature extractor ResNet from the object detection neural network as an input to the semantic feature neural network, followed by channel compression to produce a compressed feature map (CFM);
performing pyramid pooling of the CFM at different scales; and
concatenating and densely connecting the results of the pooling.

In the method described above, the training is performed as follows:
training the semantic feature neural network alone;
next, adding the global image feature neural network; and
repeating training of both the global feature and the semantic neural networks together, following the same training procedure;

Alternatively, the training may be performed by training both the global image feature neural network and the semantic feature neural network jointly together.

In the method described above, the using the trained auto-exposure neural network further
comprises one or more of the following:
predicting the optimal exposure value for the next frame;
aggregating predicted exposure values across a number of consecutive frames.

According to another aspect of the invention, there is provided a system for determining an auto-exposure value of a low dynamic range (LDR) sensor for use in high dynamic range (HDR) object detection, the system comprising:
a processor, and a memory having computer executable instructions stored thereon for execution by the processor, causing the processor to:
   form an auto-exposure neural network for predicting exposure values for the LDR sensor driven by a downstream object detection neural network in real time;
   train the auto-exposure neural network jointly, end-to-end together with the object detection neural network and an image signal processing (ISP) pipeline, thereby yielding a trained auto-exposure neural network; and
   use the trained auto-exposure neural network to generate an optimal exposure value for the LDR sensor and the downstream object detection neural network for the HDR object detection.

In the system described above, the auto-exposure neural network comprises one of the following:
a Global Image Feature neural network using histograms derived from a raw LDR image captured by the LDR sensor;
a Semantic Feature neural network based on image features extracted from the object detection neural network;
a Hybrid neural network, comprising both the Global Image Feature neural network and the Semantic Feature neural network.

In the system described above, for the hybrid neural network, the computer executable instructions further cause the processor to train the hybrid network in one of the following modes:
a first mode:
to train the semantic feature neural network alone;
next, add the global image feature neural network; and
repeat training of both the global feature and the semantic neural networks together, following the same training procedure;
or
a second mode:
to train both the global image feature neural network and the semantic feature neural network jointly together.

According to yet another aspect of the invention, there is provided a computer vision system comprising:
a low dynamic range sensor (LDR) for use in high dynamic range (HDR) object detection;
an image signal processor (ISP) for processing a raw LDR image from the LDR sensor and outputting a processed image; and
   an object detection neural network for further processing the processed image from the ISP;
   the computer vision system further comprising an apparatus for determining an auto-exposure value of the LDR sensor, the apparatus comprising:
   a processor, and a memory having computer executable instructions stored thereon for execution by the processor, causing the processor to:
   form an auto-exposure neural network for predicting exposure values for the LDR sensor driven by the object detection neural network in real time;
   train the auto-exposure neural network jointly, end-to-end together with the object detection neural network and the ISP, thereby yielding a trained auto-exposure neural network; and use the trained auto-exposure neural network to generate an optimal exposure value for the LDR sensor.

In the computer vision system described above, the auto-exposure neural network comprises a hybrid neural network, comprising a Global Image Feature neural network and the Semantic Feature neural network.

Thus, an improved method and system for auto-exposure control and selection for high-dynamic range object detection have been provided. A corresponding computer vision system is also disclosed.

### DETAILED DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of the embodiments and/or related implementations described herein and to show more clearly how they may be carried into effect, reference will now be made, by way of example only, to the accompanying drawings which show at least one exemplary embodiment and/or related implementation in which:

FIG. 1 is a schematic diagram illustrating a prior art method of using HDR imaging in a computer vision pipeline;

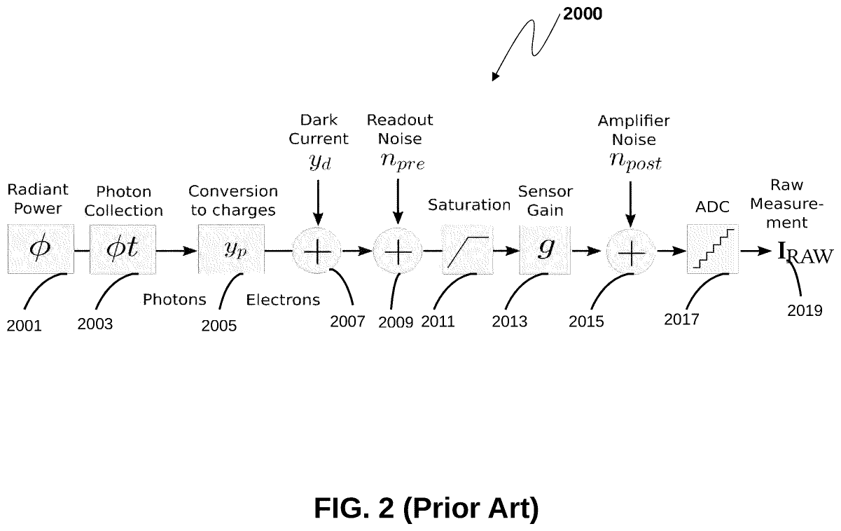

FIG. 2 is a schematic diagram illustrating a sequence of linear and nonlinear operations a physical process of the prior art;

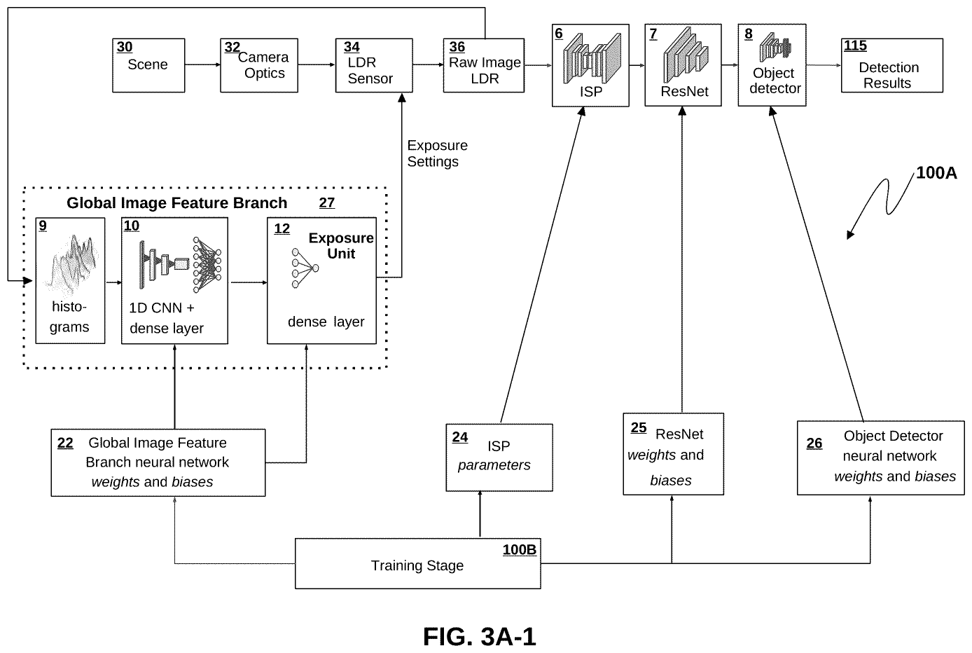

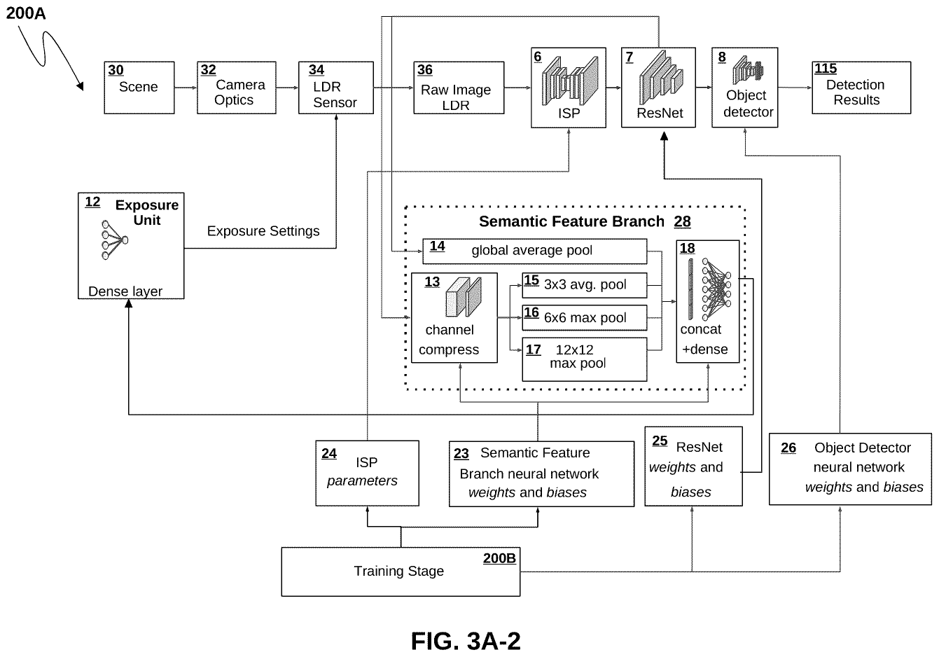

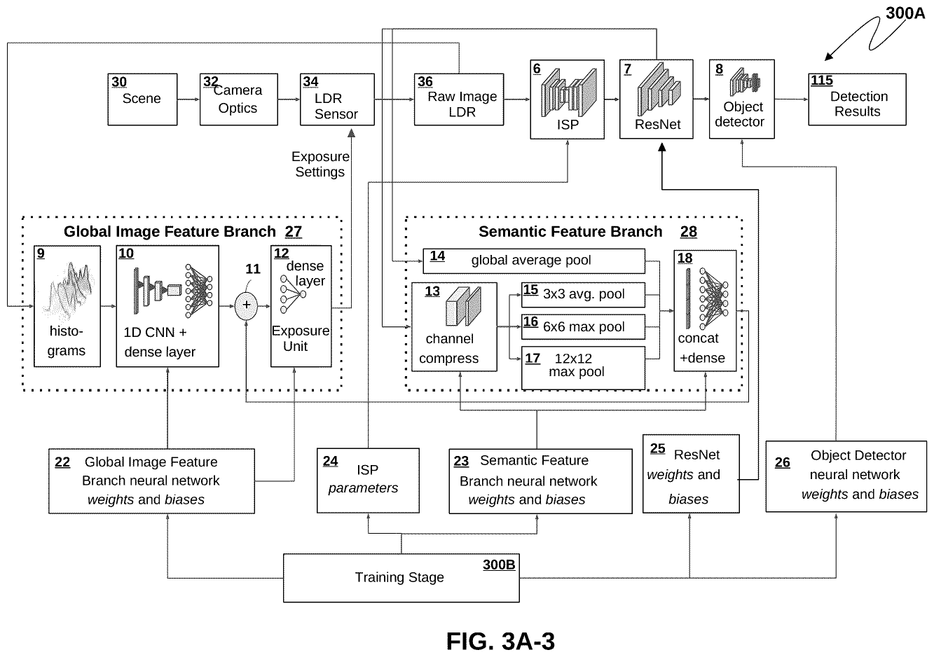

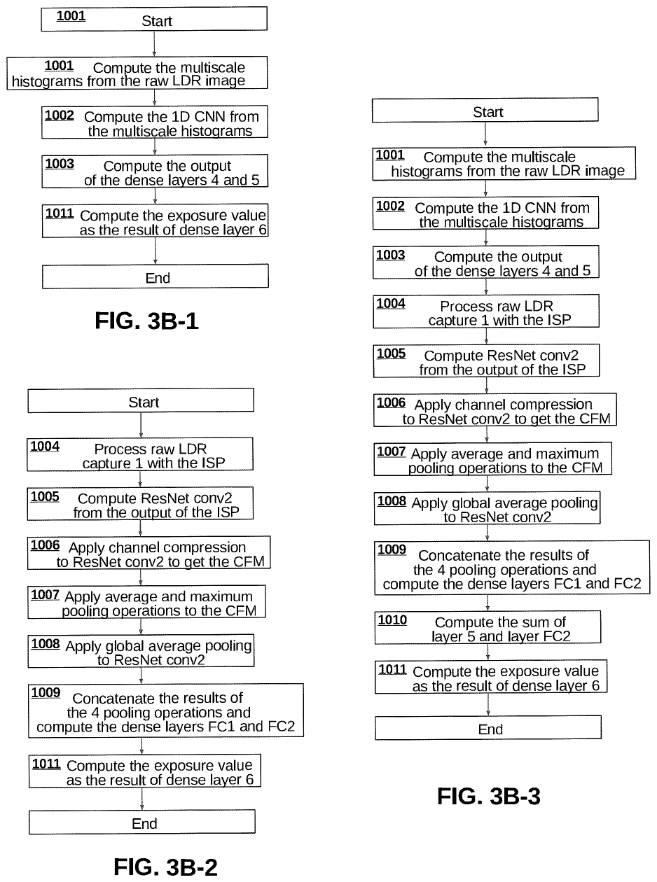

FIG. 3A-1 illustrates an operation stage of a system for end-to-end live object detection of one embodiment of the present invention including a global image feature branch;

FIG. 3A-2 illustrates the operation stage of another system of the end-to-end live object detection of another embodiment of the present invention including a semantic feature branch;

FIG. 3A-3 illustrates the operation stage of yet another system of the end-to-end live object detection of yet another embodiment of the present invention having a hybrid architecture including both the global image feature branch of FIG. 3A-1 and the semantic feature branch of FIG. 3A-2;

FIG. 3B-1 illustrates a method of operation of the system of FIG. 3A-1;

FIG. 3B-2 illustrates another method of operation of the another system of FIG. 3A-2;

FIG. 3B-3 illustrates yet another method of operation of the yet another system of FIG. 3A-3;

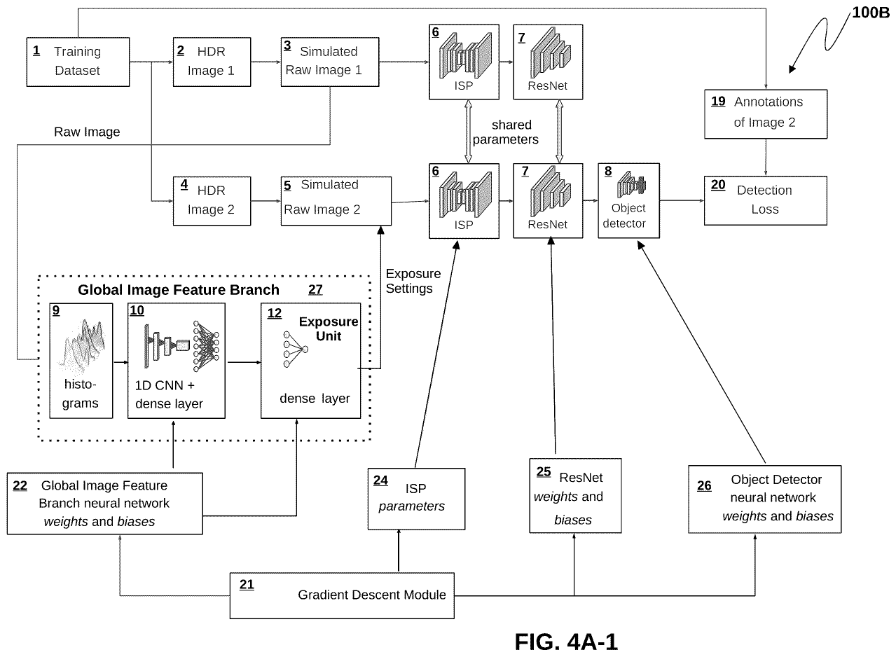

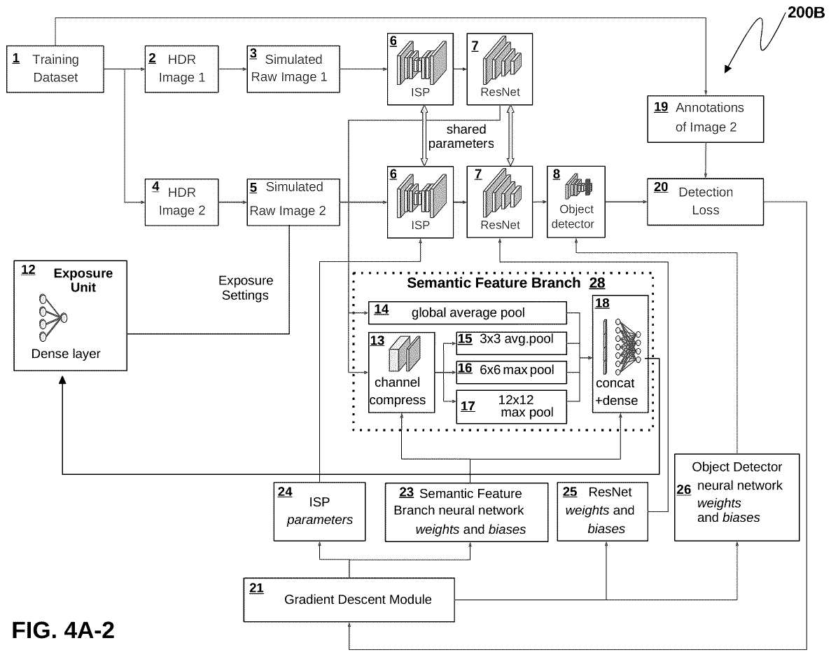

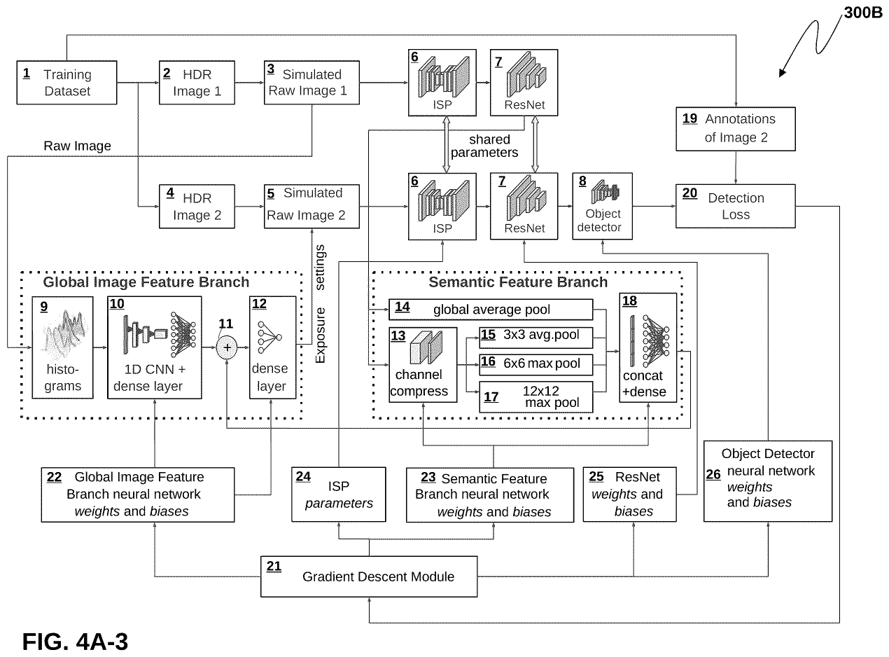

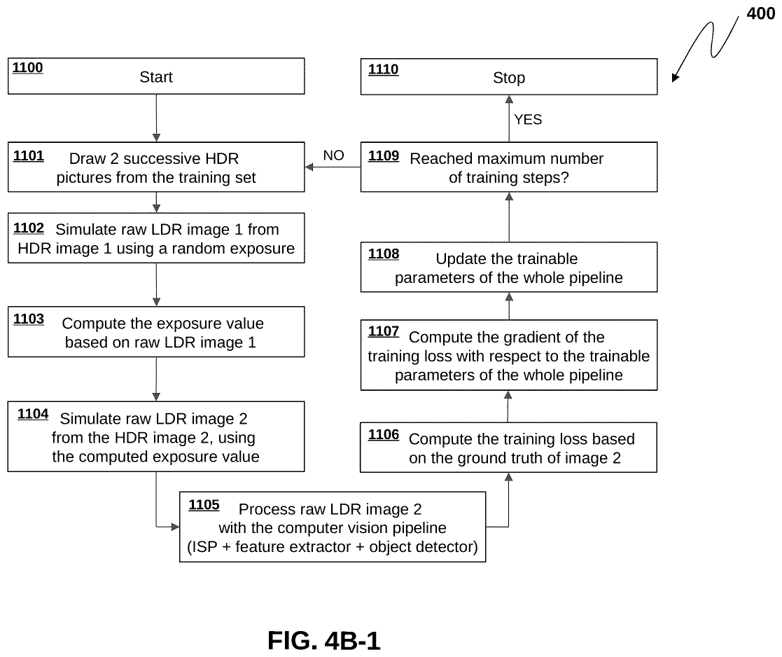

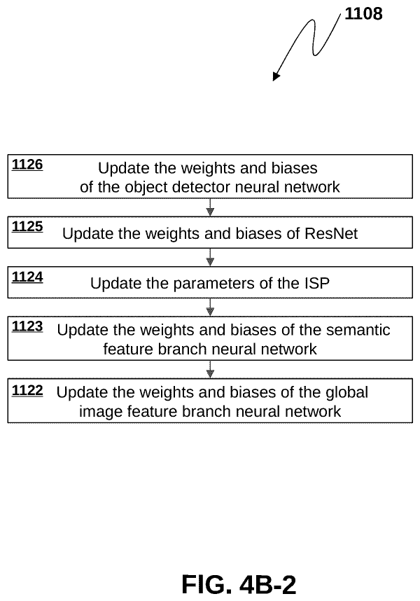

FIG. 4A-1 illustrates a training stage of the system of FIG. 3A-1;

FIG. 4A-2 illustrates the training stage of the another system of FIG. 3A-2;

FIG. 4A-3 illustrates the training stage of yet another system of FIG. 3A-3;

FIG. 4B-1 illustrates a high-level operational flow-chart corresponding to the end-to-end training methodology of the present invention;

FIG. 4B-2 illustrates another high-level operational flow-chart corresponding to the end-to-end training methodology of the present invention, it corresponds to the details of box 1108 of FIG. 4B-1;

FIGS. 5A1, 5A2, 5A3, 5A4, 5A5 show results for the prior art method of Average Auto-exposure calculation for exposure shifts k=1.5, k=4, k=1.5, k=1.5 and k=4 respectively;

FIGS. 5B1, 5B2, 5B3, 5B4, 5B5 illustrate results for the prior art method of Gradient Auto-exposure calculation for exposure shifts k=1.5, k=4, k=1.5, k=1.5 and k=4 respectively;

FIGS. 5C1, 5C2, 5C3, 5C4, 5C5 illustrate results for the histogram method of FIG. 3A-1 of the present invention for exposure shifts k=1.5, k=4, k=1.5, k=1.5 and k=4 respectively;

FIGS. 5D1, 5D2, 5D3, 5D4 and 5D5 illustrate results for the hybrid method of FIG. 3A-3 of the present invention for exposure shifts k=1.5, k=4, k=1.5, k=1.5 and k=4 respectively;

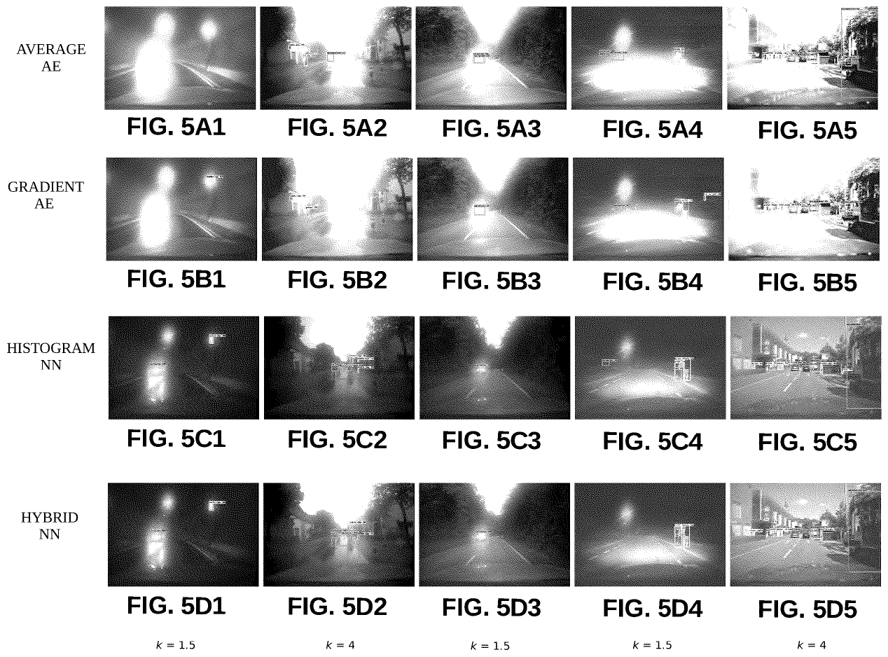

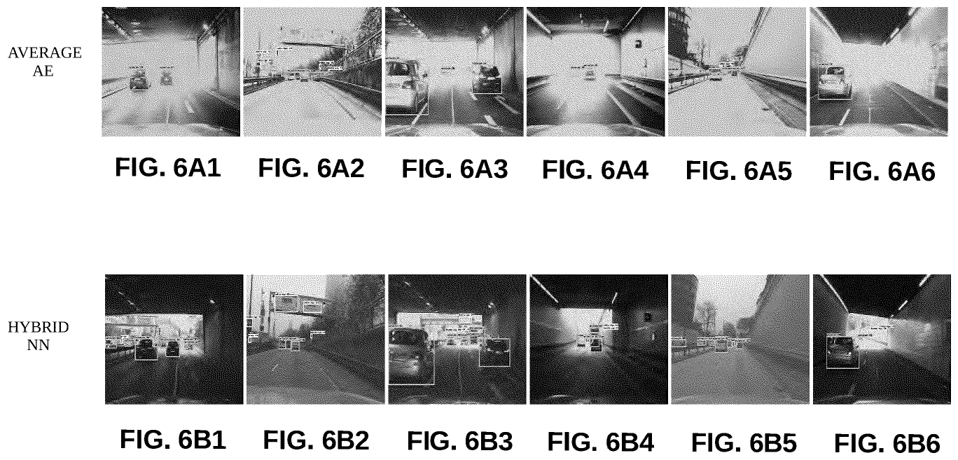

FIGS. 6A1, 6A2, 6A3, 6A4, 6A5, 6A6 and FIGS. 6B1, 6B2, 6B3, 6B4, 6B5, 6B6 illustrate experimental prototype results obtained according to a prior art method and according to the method of the present invention respectively;

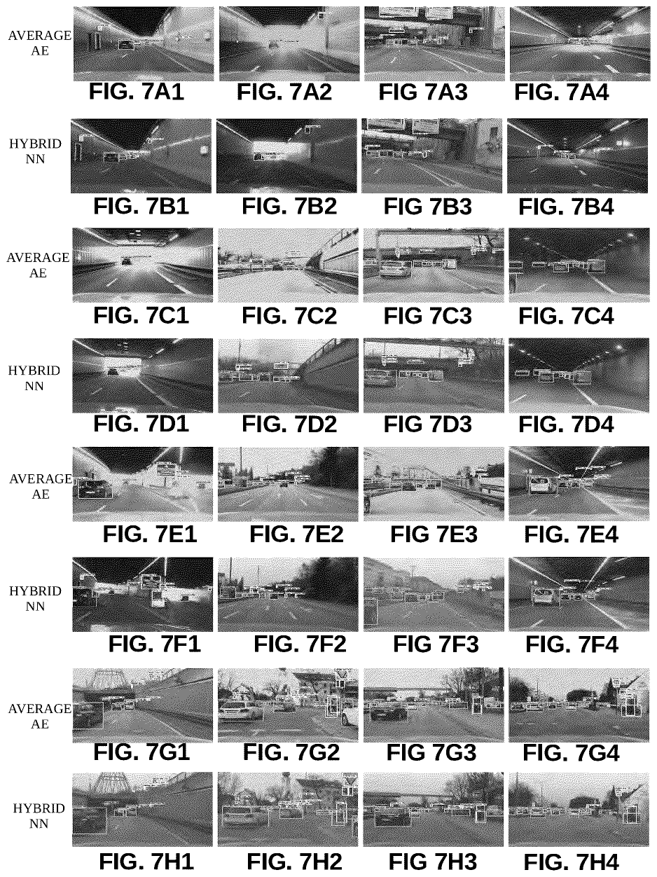

FIGS. 7A1, 7A2, 7A3, 7A4 and FIGS. 7B1, 7B2, 7B3 and 7B4 illustrate experimental prototype results obtained according to the Average AE baseline method of the prior art and according to the hybrid method of the present invention respectively;

FIGS. 7C1, 7C2, 7C3, 7C4 and FIGS. 7D1, 7D2, 7D3 and 7D4 illustrate experimental prototype results obtained according to the Average AE baseline method of the prior art and according to the hybrid method of the present invention respectively;

FIGS. 7E1, 7E2, 7E3, 7E4 and FIGS. 7F1, 7F2, 7F3 and 7F4 illustrate experimental prototype results obtained according to the Average AE baseline method of the prior art and according to the hybrid method of the present invention respectively;

FIGS. 7G1, 7G2, 7G3, 7G4 and FIGS. 7H1, 7H2, 7H3 and 7H4 illustrate experimental prototype results obtained according to the Average AE baseline method of the prior art and according to the hybrid method of the present invention respectively;

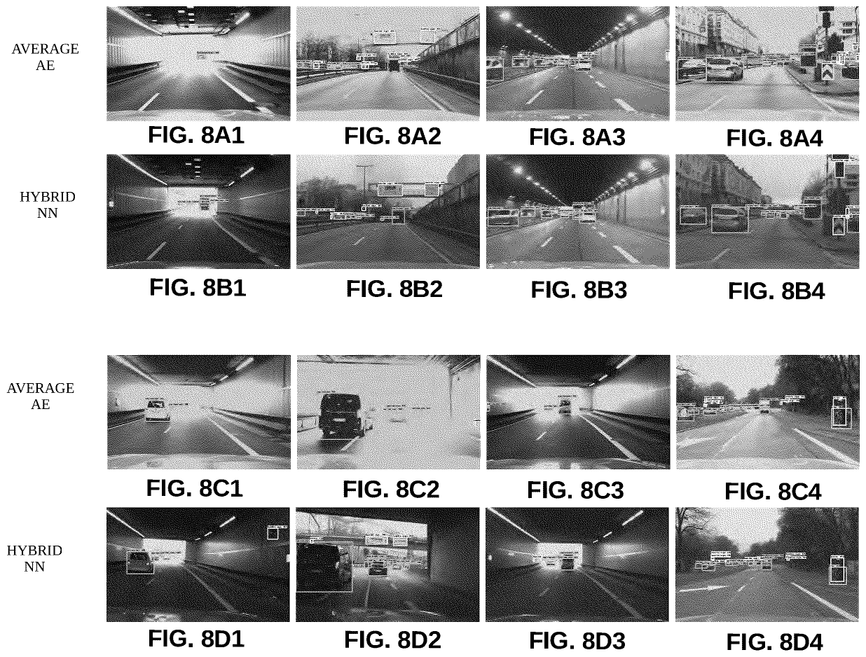

FIGS. 8A1, 8A2, 8A3 and 8A4 illustrate experimental prototype results of the Average AE baseline prior art method for a set of images/scenes, and FIGS. 8B1, 8B2, 8B3 and 8B4 illustrate experimental prototype results of the neural AEC of the hybrid method of FIG. 3A-3 for the set of images/scenes;

FIGS. 8C1, 8C2, 8C3 and 8C4 illustrate experimental prototype results of the Average AE baseline prior art method for another set of images/scenes, and FIGS. 8D1, 8D2, 8D3 and 8D4 illustrate experimental prototype results of the neural AEC of hybrid of FIG. 3A-3 for the another set of images/scenes;

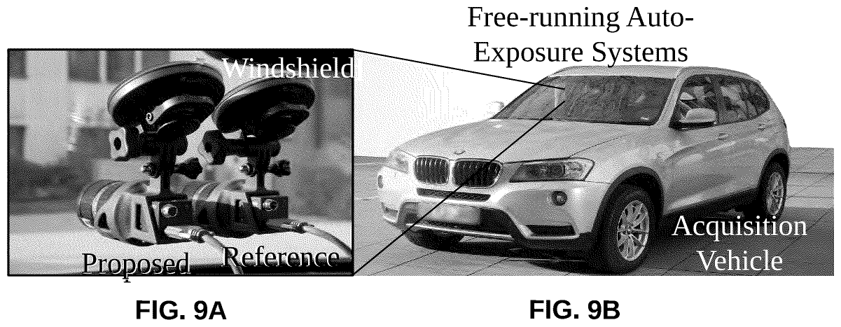

FIG. 9A illustrates an experimental capture setup for performing a side-by-side comparison of the hybrid method of FIGS. 3A-3 and 3B-3 and a prior art method based on average auto-exposure, for installation in an acquisition vehicle;

FIG. 9B illustrates the acquisition vehicle with the experimental capture setup of FIG. 9A; and

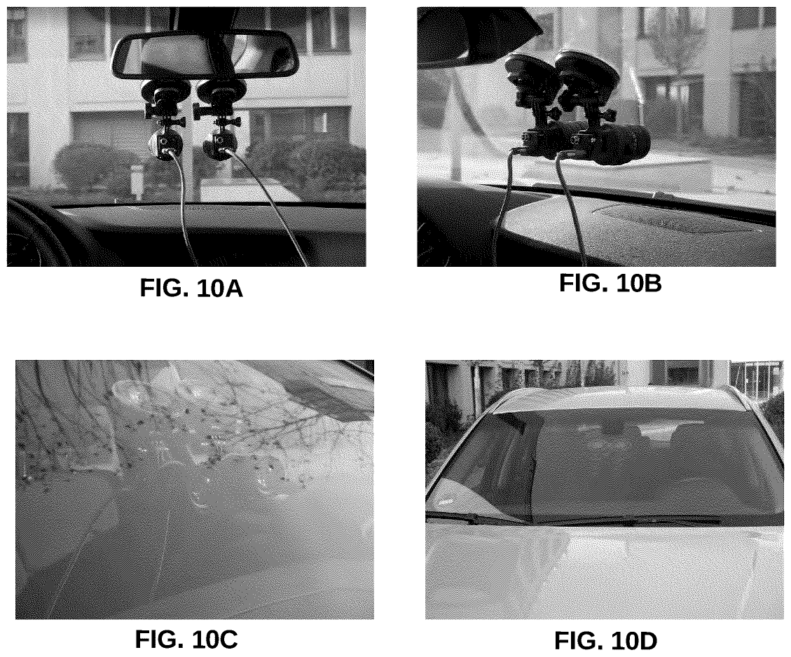

FIGS. 10A, 10B, 10C and 10D illustrates the experimental capture setup of FIGS. 9A and 9B in more detail.

### DETAILED DESCRIPTION OF THE EMBODIMENTS

In the present invention, low dynamic range (LDR) sensors have been used, and paired with learned exposure control, as a computational alternative to HDR sensors of the prior art.

The methods of the present invention are performed by employing a hardware processor. The systems described in the embodiments comprise executable instructions stored in a memory device for execution by a processor, as described in greater detail below.

### 1. IMAGE FORMATION MODEL

### 1.1 Single-Shot Image Formation

Real-world scenes are inherently HDR. Direct sunlight has a luminance around 1.6·10⁹ cd/m², while starlight lies around 10⁻⁴ cd/m². Accordingly, the total range of luminances the human eye is exposed to ranges from 10⁻⁶ cd/m² to 10⁸ cd/m² which is a range of 280 dB. However, the range of differences discernible by the eye is lower, at 60 dB in very bright conditions (contrast ratio of 1000) and 120 dB in dimmer conditions (contrast ratio of 10⁶). The dynamic range of a camera employing a 12-bit sensor is bounded from above by 84 dB because of the quantized sensing, and we note that the effective dynamic range is even lower because of optical and sensor noises (around 60-70 dB). Examples of optical noise are veiling glare, stray light and aperture ghosts. The sensor noise tends to dominate the optical noise for LDR cameras while the converse is true for HDR cameras. The dynamic range is progressively shrunk throughout the image processing pipeline, as shown for example in FIG. 1. It follows that choosing where this dynamic range lies in the scale of possible luminances is critical to capture the useful information for the task at hand. This is the role of the AEC.

The image formation model considered in this work is illustrated in FIG. 2. We consider the recording of a digital value by the sensor at a pixel as the result of the following single-shot capture process. Radiant power φ exposes the photosite during the exposure time t, creating yₚ(φ·t) photoelectrons. We express φ in electrons (e−) and t in seconds(s). Dark current creates y_{d}(μ_{d}) electrons, where m_{d} is the average number of electrons in the absence of light. This measurement results in yₑ electrons accumulated, that is

$${y}_{e} = max ( {y}_{p} ( ϕ \cdot t ) + {y}_{d} ( {μ}_{d} ) , {M}_{well} ) , \qquad ( 1 )$$

where M_{well} is the full well capacity expressed in electron. Those yₑ electrons are converted to a voltage which is amplified before being converted to a digital number that is recorded by the sensor as a pixel value. The voltage is affected by noise before amplification (readout noise) and after amplification (analog-to-digital conversion noise). This process results in the following model for raw pixel measurement. A value recorded by the sensor is expressed in digital numbers (DN), a dimensionless unit.

$${I}_{sensor} = q ( g \cdot ( {y}_{e} + {n}_{pre} ) + {n}_{post} ) , \qquad ( 2 )$$

where nₚᵣₑ is the thermal and quantum noise introduced before amplification, and nₚₒₛₜ is the readout noise introduced after and during amplification. Both nₚᵣₑ and nₚₒₛₜ are expressed in DN. The constant g is the camera gain, it is expressed in digital number per electron (DN/e−). It can be broken down into g=K·g₁, where g₁ is the gain at ISO 100 and K is the camera setting of the gain, i.e. K=1 for ISO 100, K=2 for ISO 200, etc. The function q corresponds with the quantization performed by the analog-to-digital conversion,

$$q ( x ) = min ( ⌊ x + 0.5 ⌋ , {M}_{white} ) . \qquad ( 3 )$$

The constant M_{white} is the white level, i.e. the maximum value that can be recorded by the sensor. Here we assume that the image of the targeted camera is recorded as a 12 bit raw image so we use M_{white}=2¹²−1. For the purpose of training with stochastic gradient descent we override the gradient of the floor function as the function uniformly equal to 1, i.e. the gradient is computed as if floor was replaced by the identity function. In the model presented above, the quantization is modeled explicitly with function q as compared to the prior art, where the quantization is modeled as a quantization noise, which they include in the post amplification noise nₚₒₛₜ. However, the quantization error is still expressed as a variance when considering the signal-to-noise ratio (SNR).

FIG. 2 illustrates a physical process 2000 where the radiant power is collected at step 2001, and passed onto a photon collection step 2003, after which the photons experience conversion to charges at step 2005, and the resulting electrons are tainted with additional noise electrons due to dark current at step 2007. The following steps include noise readout 2009, saturation 2011, sensor gain 2013, and amplifier noise sensing 2015. The step 2015 is the addition of the amplifier noise to the output of the sensor gain. In practice, it is impossible to separate the addition of amplifier noise from the sensor gain operation, however, it is a mathematical convenience to represent the combination of amplifier noise to sensor gain, which helps to understand at which point in the process the amplifier noise appears. The next step is the Analog-to-Digital Conversion (ADC) 2017, which entails quantization and clipping of the value between 0 and the maximum encodable value M_{white}. The result is yielding a raw measurement at step 2019. In other words, the radiant power 2001 at a photosite goes through a sequence of linear and nonlinear operations to result in a digital value which is the sensor's output. Each of these steps add noise and affects the overall image quality.

### 1.2 Noise Model

The number of photoelectrons yₚ(φ·t) and dark currents electrons y_{d}(μ_{d}) is modeled for a given pixel with Poisson distributions.

$${y}_{p} ( ϕ \cdot t ) ∼ P ( ϕ \cdot t ) , {y}_{d} ( {μ}_{d} ) ∼ P ( {μ}_{d} )$$

The average number of electrons in the absence of light μ_{d} grows linearly with the exposure time

$${μ}_{d} = {μ}_{0} + {μ}_{I} \cdot t$$

The effect of temperature on μ_{d} is ignored.

Due to the properties of the Poisson distribution the variance equals the mean value, i.e. the standard deviations are as follows.

$$σ ( {y}_{p} ( ϕ \cdot t ) ) = \sqrt{ϕ \cdot t} , σ ( {y}_{d} ( {μ}_{d} ) ) = \sqrt{{μ}_{0} + {μ}_{I} \cdot t}$$

The pre- and post-amplification noises are modeled as zero-mean gaussian variables.

$${n}_{pre} ∼ N ( 0 , {σ}_{pre}^{2} ) , {n}_{post} ∼ N ( 0 , {σ}_{post}^{2} )$$

Note that constants μ_{d}, σₚᵣₑ and σₚₒₛₜ need to be calibrated.

The above sensor noise and the quantization noise of the ADC 2017 affect the overall signal-to-noise ratio (SNR) and the dynamic range (DR) of the captured image.

### 1.3 SNR and Dynamic Range

Noise Variance. The total variance of the noise for unsaturated pixels of a single exposure can be derived from the model above. The unsaturated pixel value can be written as

$${I}_{unsat} = g \cdot ( {y}_{p} ( ϕ \cdot t ) + {y}_{d} ( {μ}_{d} ) + {n}_{pre} ) + {n}_{post}$$

and its variance

$${V}_{u nsat} = {g}^{2} \cdot ( ( ϕ + {μ}_{I} ) \cdot t + {μ}_{0} + {σ}_{pre}^{2} ) + {σ}_{post}^{2} + {σ}_{q}^{2} .$$

The square error

$${σ}_{q}^{2}$$

accounts here for the quantization error. We take it as the variance of the uniform probability distribution on [0, 1], i.e.,

$${σ}_{q}^{2} = 1 / 12.$$

### Signal-to-Noise Ratio.

The squared signal-to-noise ratio (SNR) for a pixel receiving the radiant power φ can be derived as follows.

$${SNR ( ϕ )}^{2} = \frac{{ϕ}^{2} \cdot {t}^{2} \cdot {δ}_{{I}_{sensor}} < {M}_{white}}{( ϕ + {μ}_{I} ) \cdot t + {μ}_{0} + {σ}_{pre}^{2} + ( {σ}_{post}^{2} + {σ}_{q}^{2} ) / {g}^{2}}$$

The term δ_{I}_{ₛₑₙₛₒᵣ}<M_{white} which is equal to 1 whenever the pixel value is below the maximum possible value and 0 otherwise, expresses the fact that the information is lost when a pixel is saturated at maximum value. For most sensors, the following is true for all ISO settings

$${M}_{white} < g \cdot {M}_{well} ,$$

making M_{white} the deciding quantity for saturation. It could be argued that this loss of information may happen at lower values too, because of saturation at M well followed by a negative noise nₚₒₛₜ. We ignore this possibility here.

Dynamic Range. The dynamic range DR expressed in dB, is limited by the saturation at the higher end and by noise at the lower end. Here we consider the image sensor noise and ignore the optical noise which is acceptable for an LDR single-shot camera. Let φₛₐₜ be the irradiance such that, on average, the pixel value just reaches M_{white}, i.e.

$$g \cdot ( {ϕ}_{sat} \cdot t + {μ}_{0} + {μ}_{I} \cdot t ) = {M}_{white}$$

and let φₘᵢₙ be the irradiance such that the SNR equals 1. Solving for φ in the squared SNR expression we get:

$${ϕ}_{min} = 1 + \sqrt{1 + 4 t \cdot v} / ( 2 t )$$

$$with$$

$$v = {μ}_{I} + ( {μ}_{0} + {σ}_{pre}^{2} + ( {σ}_{post}^{2} + {σ}_{q}^{2} ) \cdot {g}^{- 2} ) / t .$$

The dynamic range DR expressed in dB is defined as

$$DR = 20 \cdot {log}_{10} ( \frac{{ϕ}_{sat}}{{ϕ}_{min}} ) .$$

### 2. LEARNING EXPOSURE CONTROL

As a computational alternative to the popular direction of HDR sensors, low dynamic range sensors are revisited, and paired with learned exposure control. In the present invention, single-shot imaging is proposed with a learned adaptive exposure for dynamic scenes, departing from multi-capture methods that are fundamentally limited in dynamic scenes.

FIGS. 3A-1, 3A-2 and 3A-3 illustrate various embodiments of the operation stage of the system for the end-to-end live object detection method with neural auto exposure control.

In particular, FIG. 3A-1 illustrates the operation stage of the system for end-to-end live object detection of one embodiment of the present invention including the global image feature branch. FIG. 3A-2 illustrates the operation stage of another system of the end-to-end live object detection of another embodiment of the present invention including a semantic feature branch, while FIG. 3A-3 illustrates the operation stage of yet another system of the end-to-end live object detection of yet another embodiment of the present invention having a hybrid architecture including both the global image feature branch of FIG. 3A-1 and the semantic feature branch of FIG. 3A-2.

Accordingly, FIG. 3B-1 illustrates a method of operation of the system of FIG. 3A-1; FIG. 3B2 illustrates another method of operation of the another system of FIG. 3A-2; and FIG. 3B-3 illustrates yet another method of operation of the yet another system, or hybrid system of FIG. 3A3, showing the production pipeline for the AE model based on both branches.

In the pooling operations in the above figures, n×n does not refer to a receptive field, but means the feature map is divided up into a n by n array.

More specifically, given a captured frame number t, the proposed learned exposure control network predicts the exposure and gain values of the next frame number t+1 from either a global image statistics or scene semantics, or both in two network branches. The global image feature branch operates on a set of histograms computed from the image at three different scales (and in general at M different scales). While this branch efficiently encodes global image features, the semantic feature branch exploits semantic features that are shared with a downstream object detector module. The two branches can either be used independently or jointly. We refer to the joint model as “Hybrid NN”, or Hybrid Neural Network.

### 2.1. Operation Stage—Global Image Feature Branch

As mentioned above, FIG. 3A-1 illustrates the operation stage 100A of the system for end-to-end live object detection of one embodiment of the present invention including the global image feature branch 27.

Camera optics 32 alters a path of light rays from a scene 30 to be captured, such that an image of the scene captured by an LDR sensor 34 is in focus. The capture happens at the LDR sensor 34 producing an LDR raw image 36.

The exposure time is set in the LDR sensor 34, but the computation of the actual exposure value, or exposure setting, is performed outside of the sensor 34, namely the exposure value/setting is computed in the Exposure unit 12 of the Global Image Feature Branch 27, as will be described in detail below.

The raw LDR image is supplied to an Image Signal Processor (ISP) 6. An output from the ISP 6 is a processed image, which is further supplied to a Residual Network ResNet 7 or a neural network 7, followed by Object detection 8 and displaying detection results 115. ResNet 7 neural network is a feature extractor, which acts as a preprocessing step before applying the Object detector 8, which is also a neural network, but it cannot be applied directly to the processed image, it needs the output of the feature extractor ResNet 7.

Operational ISP parameters 24, ResNet weights and biases 25, Object Detector neural network weights and biases 26, and Global Feature Branch neural network weights and biases 22 are supplied from the Training Stage 100B, the Training Stage 100B to be described in detail below with regard to FIGS. 4A-1 and 4B-1.

In the Global Image Feature branch 27, to incorporate global image statistics without the need for a network with a very large receptive field, we rely on histogram statistics as input. We note that histogram statistics can be estimated with efficient ASIC blocks on the sensor or in a co-processor. In one embodiment, we compute the histogram from green pixel values of the raw LDR image, but it is understood that histogram could be also computed from the luminance, or the other pixels as well.

In one embodiment, the input to the global image feature branch 27 is a tensor of shape that represents 59 histograms, each with 256 bins, stacked together (FIG. 3A-1 box 9, FIG. 3B-1 box 1001). These histograms are computed at three different scales (details not shown in FIGS. 3A and 3B).

The coarsest scale is the whole image which yields one histogram.

At the intermediate scale, h1 histograms are computed, for example 9 histograms are computed, following a 3 by 3 division of the image, or by h1×h1 division in general case.

At the finest scale, the image is divided up into h2×h2, for example 7 by 7 sub-images, yielding 49 histograms, or h2×h2 histograms in general case. After computation and stacking of the histograms, the global image feature branch starts with a one-dimensional convolutional neural network (CNN) (FIG. 3A-1 box 10, FIG. 3B-1 box 1002). The first 3 layers are 1D convolutions where the convolution operates along the histograms. The width of the layers increases by doubling every layer, starting at 128. The convolution kernel size and the stride are equal to 4. We also expect that using similar values for the convolution kernel size and stride would also work, for example kernel size in {2, 3, 4, 5, 6, 7, 8} and stride in {1, 2, 3, 4}. Using a larger kernel and a smaller stride may result in more computations. Using a smaller kernel and a larger stride would result in less computations but might also result in less accurate auto-exposure. Usually, an empirical search only can guide us towards better suitable values for these parameters.

Three dense layers follow, with a decreasing number of units, 1024 units for Layer 4, 16 units for Layer 5 and a single unit for Layer 6 which is the last layer (FIG. 3A-1 box 10 and FIG. 3B-1 boxes 1003 for Layers 4 and 5, FIG. 3A-1 box 12 and boxes 1011 for Layer 6).

Although we have experimented with only one scale and three scales in the present application, it is possible that another number of scales would work as well or possibly even better. The idea to use more than one scale is that a single histogram does not provide enough local information. For example when we are about to exit a tunnel, or just before entering a tunnel, the histogram at the center of the image is different from the histogram elsewhere.

Each of the layers 1 to 5 are followed by a Rectified Linear Unit (ReLU) activation function. The last layer is followed by a custom activation function that computes the final exposure adjustment for frame number t as:

$${u}_{t} = exp ( 2 \cdot ( sigmoid ( x ) - 0 \text{.5} ) \cdot log ( {M}_{exp} ) ) \qquad ( 4 )$$

where x is the preactivation of Layer 6. The constant Mₑₓₚ>0 is the maximum exposure change, it is a bound such that

$${u}_{t} ∈ [ {M}_{exp}^{- 1} , {M}_{exp} ] .$$

In this implementation Mₑₓₚ=10 is chosen. Mₑₓₚ=10 quantifies by how much we challenge the auto-exposure module by presenting ill-exposed images during training. The larger it is, the more over- and under-exposed the simulated LDR images will be. The choice for maximum exposure is empirical, wherein Mₑₓₚ=10 value is for example set to the largest exposure value for which a stable training can still be performed. In our later experiments we have managed to use even larger Mₑₓₚ values, which was possible due to using a base exposure differently.

Table 1 below lays out the linear architecture of the global image feature branch 27 and recaps the hyper-parameters of each layer.

TABLE 1
Global Image Feature Branch Architecture

| | | Number | Kernel | | Output |
|---|---|---|---|---|---|
| Layer | Operation | of Filters | Size | Stride | Shape |
| 0 | Input tensor | — | — | — | [256, 59] |
| 1 | 1D Convolution | 128 | 4 | 4 | [64, 128] |
| 2 | 1D Convolution | 256 | 4 | 4 | [16, 256] |
| 3 | 1D Convolution | 512 | 4 | 4 | [4, 512] |
| 4 | Dense layer | 1024 | — | — | [1024] |
| 5 | Dense layer | 16 | — | — | [16] |
| 6 | Dense layer | 1 | — | — | [1] |

### 2.2. Operation Stage-Semantic Feature Branch

FIG. 3A-2 illustrates the operation stage 200B of another system of the end-to-end live object detection of another embodiment of the present invention including a semantic feature branch 28.

Similar to that of FIG. 3A-1, camera optics 32 alters a path of light rays from a scene 30 to be captured, such that an image of the scene captured by an LDR sensor 34 is in focus. The capture happens at the LDR sensor 34 producing an LDR raw image 36.

The exposure time is set in the LDR sensor 34, but the computation of the actual exposure value, or exposure setting, is performed outside of the sensor 34, namely the exposure value/setting is computed in the Exposure unit 12 with the input from the box 18 of the Semantic Feature Branch 28, as will be described in detail below.

The raw LDR image is supplied to an Image Signal Processor (ISP) 6. The output from the ISP is a processed image, which is further supplied to a Residual Network ResNet 7 or a neural network 7, for further processing, followed by Object detection 8 and displaying detection results 115.

ISP parameters 24, Semantic Feature Branch neural network weights and biases 23, Resnet weights and biases 25, and Object Detector neural network weights and biases 26 are supplied from the Training Stage 100B, the Training Stage 200B to be described in detail below with regard to FIGS. 4A-2 and 4B-1.

The Semantic Feature branch 28 incorporates semantic feedback into the auto-exposure control unit 12. To this end, we reuse the computation of the feature extractor of the object detector from the current frame. We use the output of ResNet conv2 (FIG. 3A-2 box 7, FIG. 3B-2 box 1005) as the input to the semantic feature branch 28. We first apply channel compression from 64 to 26 channels and refer to the output as the compressed feature map (CFM) (FIG. 3A-2 box 13, FIG. 3B-2 box 1006). Then we apply pyramid pooling at 4 scales (FIG. 3A-2 boxes 14, 15, 16, 17, and FIG. 3B-2 boxes 1007 and 1008). At the coarsest of the four scales we apply average pooling of the output of conv2 along the two spatial dimensions (FIG. 3A-2 box 14, and FIG. 3B-2 box 1008). At the finest scales we use growing size of max and average pooling operations on the CFM (FIG. 3A-2 boxes 15, 16, 17, and FIG. 3B-2 box 1007).

We now provide more details of the architecture of the semantic feature branch 28 of the embodiment of the invention. At the beginning of the semantic feature branch 28, the ResNet conv2 (box 7) feature map is first cropped. The first 120 rows only are kept. The number of rows of 120 has been selected for convenience and being divisible by 40 while 150, the original height of the feature map, is not. This makes it easy to do the operation Avg pool 1 which kernel has height 40. This makes for a convenient shape when pooling at different scales later (this cropping is not shown in FIGS. 3A-2 and 3B-2). It is also noted that no important information is lost in the process given that the bottom of the image is mostly occupied by the hood of the car. After that cropping, the feature map undergoes a channel compression from 64 to 26 by using a 1×1 convolution, producing the compressed feature map (CFM) (FIG. 3A-2 box 13, FIG. 3B-2 box 1006). The channels of the CFM are pooled at 3 different scales (FIG. 3A-2 boxes 15, 16, 17, and FIG. 3B-2 box 1007). The first two channels are max pooled with a stride of 10 along rows and 20 along columns, which amounts to dividing up the feature map along rows and columns into a 12 by 12 array of sub tensors and computing the maximum of each of them channel wise (FIG. 3A-2 box 17, and FIG. 3B-2 box 1007). The next 8 channels of the CFM are max pooled with a stride of 20 along rows and 40 along columns, which amounts to dividing up the feature map into a 6 by 6 array of sub tensors and computing the maximum of each of them channel wise (FIG. 3A-2 box 16, and FIG. 3B-2 box 1007). The last 16 channels of the CFM are average pooled with a stride of 40 along rows and 80 along columns, which amounts to dividing up the feature map into a 3 by 3 array of sub tensors and computing the average of each of them channel wise (FIG. 3A-2 box 15, and FIG. 3B-2 box 1007). A fourth pooling is performed image wide on the cropped (64-channel) feature map, i.e. each of the 64 channels is averaged along the two spatial dimensions (FIG. 3A-2 box 14, and FIG. 3B-2 box 1008). Each of the tensors resulting from those 4 pooling operations are flattened, yielding vectors of lengths 288, 288, 144, and 64 respectively. They are concatenated together to give a 784-long vector (FIG. 3A-2 box 18, and FIG. 3B-2 box 1009). Those 784 units are then densely connected to a 16-unit layer which is the output of the semantic feature branch 28 (FIG. 3A-2 box 18, and FIG. 3B-2 box 1009).

The output from box 18 is supplied to the Exposure Unit 12 for calculating exposure setting, namely: The resulting vector of length 16 is followed by a common final densely connected layer with a custom activation function as described in Section 4.1 (equation (4)) (FIG. 3A-2 box 12, and FIG. 3B-2 box 1011). This final densely connected head uses both branches to make the exposure prediction.

Table 2 below details the directed acyclic graph architecture of the semantic feature branch 28 by specifying the input of each layer, as well as their hyperparameters.

TABLE 2
Semantic Feature Branch Architecture

| | | | Number | Kernel | | Output |
|---|---|---|---|---|---|---|
| Layer | Input | Operation | of Filters | Size | Stride | Shape |
| ResNet conv2 | — | Input tensor | — | — | — | [150, 240, 64] |
| Cropped feature | ResNet conv2 | Crop rows | — | — | — | [120, 240, 64] |
| map | | [0:120] | | | | |
| Compressed feature | Cropped | Convolution | 26 | 1 | 1 | [120, 240, 26] |
| map (CFM) | feature map | | | | | |
| Max pool 1 | CFM channels | Max pool | — | 10 × 20 | [10, 20] | [12, 12, 2] |
| | [0:2] | | | | | |
| Max pool 2 | CFM channels | Max pool | — | 20 × 40 | [20, 40] | [6, 6, 8] |
| | [2:10] | | | | | |
| Avg pool 1 | CFM channels | Average pool | — | 40 × 80 | [40, 80] | [3, 3, 16] |
| | [10:26] | | | | | |
| Avg pool 2 | ResNet conv2 | Average pool | — | — | — | [1, 1, 64] |
| | cropped | | | | | |
| Pool out | Max pool 1 | Flatten + | — | — | — | [748] |
| | Max pool 2 | concatenate | | | | |
| | Avg pool 1 | | | | | |
| | Avg pool 2 | | | | | |
| FC 1 | Pool out | Dense layer | 1024 | — | — | [1024] |
| FC 2 | FC 1 | Dense layer | 16 | — | — | [16] |

### 2.3 Operation Stage-Hybrid Model

FIG. 3A-3 illustrates the operation stage 300A of yet another system of the end-to-end live object detection of yet another embodiment of the present invention having a hybrid architecture including both the global image feature branch 27 of FIG. 3A-1 and the semantic feature branch 28 of FIG. 3A-2.

Similar items are designated by same reference numerals in FIGS. 3A-1, 3A-2 and 3A-3.

The hybrid system 300A differs from the global image feature system 100A and the semantic feature system 200A in that:
The Global Image Feature Branch neural network weights and biases 22, ISP parameters 24, Semantic Feature Branch neural network weights and biases 23, Resnet weights and biases 25, and Object Detector neural network weights and biases 26 are supplied from the Training Stage 300B, the Training Stage 300B to be described in detail below with regard to FIGS. 4A-3 and 4B-1; and
the output from the box 10, Layer 5 of the global image feature branch 27, and the output from the box 18 of the semantic feature branch 28, are summed at a node 11, to jointly provide input to the Exposure calculation unit 12. In more detail, the output of Layer 5 (box 10) of the global image feature branch 27 is summed to the output of the second fully connected layer (FC 2) from box 18 of the semantic feature branch 28, after rescaling. That is, the output of FC 2 is rescaled by a constant factor that we set to 0.01, which value has been so as to make the output of both branches roughly of the same magnitude. This rescaling allows the signal coming from both branches 27 and 28 to be on the same order of magnitude.

Thus, after summation at the node 11, the resulting vector of length 16 is followed by a common final densely connected layer with a custom activation function as described in Section 4.1 (equation (4)) (FIG. 3A-3 box 12, and FIG. 3B-3 box 1011). This final densely connected head uses both branches 27 and 28 to make an exposure prediction, and we refer to it as “Hybrid NN” in the following.

### 2.4 Exposure Prediction Filtering

To further improve the accuracy of the exposure control at inference time we aggregate exposure predictions across consecutive frames with an exponential moving average of the logarithm of the exposure,

$$log {e}_{t} = μ \cdot log {e}_{t - 1} + ( 1 - μ ) \cdot log ( {e}_{t - 1} \cdot {u}_{t} ) \qquad ( 5 )$$

i.e. eₜ=eₜ₋₁·uₜ^{1-μ}, where eₜ is the next exposure value, eₜ₋₁ is the exposure at the previous frame, uₜ is the exposure t adjustment predicted by the neural networks of Sections 4.1 and 4.2. We set the smoothing hyperparameter to μ=0.9 in this implementation.

Thus, the exposure prediction filtering comprises a recursive low pass filter. It is only done in operation, and used to make the auto-exposure result more stable.

2.5 Shutter Speed and Gain from Exposure Value

The neural exposure prediction described above produces a single exposure value eₜ=K·tₑₓₚ with K the gain and tₑₓₚ the exposure time. Since maximizing the exposure time maximizes the SNR, it is

$$K = max ( 1 , {e}_{t} / {T}_{max} ) , {t}_{exp} = {e}_{t} / K \qquad ( 6 )$$

where Tₘₐₓ is the maximum allowed exposure time, which we set to Tₘₐₓ=15 ms.

### 2.6 Image Signal Processing (ISP) Pipeline

The raw LDR image 36, acquired by the camera optics 32 and captured by the LDR sensor 34, is processed by a differentiable software signal image processor (ISP) 6. We provide here an example of a differentiable ISP 6 having a linear pipeline comprising the following processing blocks and trainable parameters.
1. Demosaicing. No trainable parameter.
2. Downsampling. No trainable parameter.
3. Denoising with a bilateral filter. Two trainable parameters: the range or parameter (same unit as intensity pixel values) and the spatial parameter da (pixel unit).
4. Sharpening with an unsharp mask filter. Two trainable parameters: the radius (pixel unit) and the magnitude of the sharpening (unitless positive value).
5. Gamma correction. One trainable parameter: γ.

The ISP parameters 24 are trained jointly with the other trainable variables including auto exposure, feature extractor and object detector. We note that the proposed method is orthogonal to the ISP employed, i.e. independent from structure of the ISP 6, and indeed supports arbitrary image processing pipelines, as long as those are differentiable.

In the FIGS. 3A-1, 3A-2, 3A-3 the ISP is shown in box 6, in the FIGS. 3B-1, 3A-2 and 3A3 the ISP processing is performed in the step 1004.

### 3. TRAINING

An overview of the training approach is illustrated in the system diagrams 100B, 200B and 330B of FIGS. 4A1, 4A-2 and 4A-3 respectively. The corresponding operational flow-chart 400 is shown in FIG. 4B.

Similar modules appear in both the production system diagrams (FIGS. 3A-1, 3A-2 and 3A-3) and the training system diagrams (FIGS. 4A-1, 4A-2 and 4A-3). Such modules are labeled with the same reference numerals in the above mentioned diagrams.

In the following, we describe the training methodology in detail.

In FIGS. 4A-1, 4A-2 and 4A-3, the simulated LDR images, simulated raw image 1 (box 3) and simulated raw image 2 (box 5) are simulated/made from respective captured linear HDR image 1 (box 2) and linear HDR image 2 (box 4) by the composition of the following 3 operations:
1. Scaling (multiplying all pixel values by a common factor);
2. Quantization (i.e., in practice rounding to the closest integer value); and
3. Clamping (i.e., replacing values above a given threshold M_white with the value M_white).

In FIGS. 4A-1, 4A-2 and 4A-3, for one training step, i.e. one optimization iteration, a single simulated LDR image is made from a given HDR image.

However, there are many more iterations than HDR images in the training set, so a given HDR image is used several times during the training.

Each time the HDR image is used, it yields a different LDR image, because generation of the LDR image depends on the random exposure shifts, which is different at each iteration. In our implementation we train the neural network for 60,000 iterations, and the training set has about 1600 training examples, so a given HDR image is used about 38 times during training.

### 3.1. HDR Training Dataset

Real life data is collected by the HDR sensor, and the HDR sensor can output:
a single raw linear HDR image, for example by setting the HDR sensor to produce a linear HDR image when collecting HDR data for the training dataset;
or
a set of “n” raw linear LDR images (to be fused into a single linear HDR image), which exposures are selected such that a combined dynamic range of the “n” linear LDR images would cover the same dynamic range as the single HDR image.

Remark that in both cases we can still save the training dataset on the hard drive as linear HDR images instead of sets of n LDR images. In such a case, we would avoid the process of generating the linear HDR image from the n LDR images during training, which could save processing time. On the other hand, a set of tonemapped LDR images takes less space on the hard drive than the corresponding linear HDR image, because image compression algorithms are designed for tonemapped LDR images.

Also if the time to load data from the hard drive is significant in the training pipeline, then using the set of n LDR images would be more advantageous. On the other hand if the conversion from the set of LDR images to the linear HDR image takes more time, then it would be better to store the linear HDR image directly, to avoid generating it during training.

For example, JPEG images are convenient to save disk space and time when loading training examples, rather than using the 24 bit linear images directly to make the data set.

Either the raw linear HDR image or corresponding “n” raw linear LDR images may be used to create the training dataset. When corresponding “n” raw linear LDR images are used, they need to be combined (fused) into the single linear HDR image, as will be described in detail in the subsection Latent HDR Image below.

The advantage of fusing the LDR images ourselves instead of letting the HDR image sensor do it, is that we may use a better fusion algorithm than the one used by the HDR sensor.

Either way, the linear HDR image for the training dataset is formed, either as a direct output of the HDR sensor, or as a fusion of n LDR images outputted by the HDR sensor.

In one embodiment, the HDR image data takes the form of three LDR JPEG images that are combined at training time to form a linear HDR color image. This combination could also be done at the dataset creation as mentioned above.

Preferably, each LDR image is captured as JPEG image, which is transformed into a linear LDR image by:
(i) Scaling, or multiplying all pixel values by a common factor;
(ii) Quantization, i.e., in practice rounding to the closest integer value; and
(iii) optionally Clamping, i.e., replacing values above a given threshold M_white with the value M_white;
   followed by combining n linear LDR images into a single linear HDR (Ihdr) image taking into account weighted average of pixel values across “n” LDR images with weight equal to the inverse of the noise variance.

The training dataset has 1600 pairs of HDR images that have been acquired using a test vehicle and the Sony IMX490 HDR image sensor. Each pair of HDR images contains two successive frames of which the second one has been manually annotated for automotive 2D object detection. About 50% of the HDR images have been taken during daytime, 20% at dusk and 30% at nighttime, with diverse weather conditions. The driving locations include urban and sub-urban areas, countryside roads and highways. The raw HDR data has been processed by a state-of-the-art ARM Mali C71 ISP to obtain 3 LDR images. Those images are rescaled to the definition of the target image sensor (Sony IMX249) and saved in the sRGB color space.

### 3.2 LDR Image Capture Simulation

The proposed training pipeline simulates LDR raw images 1 and 2 from corresponding HDR images 1 and 2 from the training dataset 1.

The LDR image formation is shown in FIGS. 4A-1, 4A-2 and 4A-3 in boxes 3 and 5, and in FIG. 4B-1 in boxes 1102 and 1104. We also provide additional details below.

The AEC model is trained on LDR raw images simulated using the image formation model from Sec. 3. Specifically, we calibrate the sensor noise parameters and use them to set a camera gain K and exposure time, t. The camera comprises the camera optics 32 and the LDR sensor 34, and the gain K here is the gain setting of the LDR sensor 34.

The radiant power ø for each pixel of the LDR image is simulated using HDR images taken by a 140 dB HDR camera. This is done by taking n JPEG encoded LDR images whose combined dynamic range covers the full 140 dB of the HDR image. n LDR images correspond to a single HDR image, these n LDR images are taken by the HDR image sensor. This HDR sensor can either output these n LDR images which can then be combined (“fused”) into an HDR image, as described in the present application, or the HDR sensor can output an HDR image by doing the fusion of the LDR images to an HDR image internally.

More specifically, for each LDR image Jᵢ, the scaled linear image is, Iᵢ=αᵢ·φ(Jᵢ). Here the exposure factor αᵢ=(Kᵢ·tᵢ)⁻¹ is decreasing with i, and φ is the inverse tonemapping operator to recover a linear image in [0, 1]. Hence, each scaled image/¿ has values in the range [0,αᵢ].

Radiant power simulation is done at the training stage, when simulating an LDR captured image. It is essentially a scaling of the linear HDR image (from the training dataset) by a factor common to all pixels of the images. This scaling accounts for the exposure of the simulated captured image to a base exposure followed by a random exposure shift.

The base exposure is such that the image is more or less well exposed, following a simple heuristic. It is a scaling that can also be done offline, i.e., before training, just by doing the corresponding scaling for each of the linear HDR images before saving them to disk in the training dataset (i.e., at training set creation).

The random exposure shift, on the other hand, is freshly sampled at each training step, such that a given training image can be used for several training steps with different exposure shifts. So the random exposure shift can only be done during training. It is essentially a challenge to the auto-exposure module 12 to train it to adapt to ill-exposed images.

We simulate LDR images rather than use LDR images produced by the HDR sensor for two reasons:
1. For the first image, a Simulated Raw Image 1, of the two images of the mini-sequence of the training example of FIGS. 4A1-, 4A2 and 4A3 which will be described in detail below, we want to apply a random exposure shift, where the exposure shift is randomly sampled within a predetermined range. This can only be done with simulation. If we used one of the n LDR images recorded by the HDR sensor, we would be limited to these exposures only, whereas the simulation allows an infinite number of possible exposures.
2. For the second image, a Simulated Raw Image 2 of FIGS. 4A1-, 4A2 and 4A3, we need to have an image that would result from the capture made with the exposure setting computed by applying the auto-exposure module to the first image Simulated Raw Image 1, and this can only be achieved by simulation. It is very unlikely that one of the n LDR images recorded by the HDR sensor would exactly match the exposure predicted by the auto-exposure module.

Latent HDR Image. A linear HDR image I_{hdr} is produced from the n scaled linear LDR image images by computing the minimum variance unbiased estimator, i.e., the weighted average of pixel values across the set of n LDR images with weights equal to the inverse of the noise variance,

$${I}_{hdr} = \frac{{\sum }_{i = 1}^{n} {w}_{i} \cdot {I}_{i}}{{\sum }_{i = 1}^{n} {w}_{i}} with I = \frac{{δ}_{{I}_{i} < {M}_{white}}}{{α}_{i}^{2} \cdot {V}_{unsat}} \qquad ( 7 )$$

where Vᵤₙₛₐₜ is the variance of unsaturated pixels.

Radiant Power Simulation. We simulate the radiant power per pixel φₛᵢₘ with the help of the linear HDR image I_{hdr} described above, φₛᵢₘ:=Bayer(γ·I_{ndr}). Here Bayer is the Bayer pattern sampling of the image sensor. The constant γ allows to scale the values to a range that is appropriate for the given camera.

### 3.3 Noise Simulation

In the FIGS. 4A-1. 4A-2, 4A-3. 4B-1 and 4B-2, the noise simulation takes place in the same boxes as the LDR image capture simulation, even though details about noise simulation are not shown on those Figures. More specifically, FIG. 4B-2 outlines the details for box 1108 from FIG. 4B-1, namely, how to update the trainable parameters of the whole pipeline.

Sensor noise is simulated at training time to match the noise distribution of the target LDR sensor. Since the dataset images already contain some noise, we add only the amount that reproduces noise characteristics of the target sensor through noise adaptation. We also apply noise augmentation for each training example by randomly varying the strength of the simulated noise around the noise strength targeted by noise adaptation.

In further detail, noise simulation is done at the training stage, when simulating an LDR captured image. This is done by sampling a random variable that follows the probability distribution of the noise of the targeted sensor.

The probability distribution has been estimated (“calibrated”) beforehand. It cannot be done at training dataset creation, because it depends on the random exposure shifts, which is different at each training step. In addition it is better to sample a fresh new noise for each training step. Using the same noise at several training steps could lead to overfitting to that particular noise.

Noise Parameterization for Calibration and Capture Simulation. For the purpose of calibration and simulation we combine μ₁, μ₀ and σₚᵣₑ to a single term

$${σ}_{d}^{2} ,$$

which we call the variance of the dark noise, as follows:

$${σ}_{d}^{2} = {μ}_{I} \cdot t + {μ}_{0} + {σ}_{pre}^{2} .$$

We do this for two reasons. The first reason is that we consider the exposure time as being fixed in the training pipeline, i.e. that the AEC only adjusts the gain. This is an approximation which ignores that the camera gain setting K is bounded from below by 1. This approximation overestimates the standard deviation of the noise in the case where K<1 is simulated. However, in the case of the target camera, the error induced by that approximation is bounded from above by 0.54·M_{white}, such that we deem this approximation as acceptable in practice. The second reason for grouping those noise terms under

$${σ}_{d}^{2}$$

is that we do the common approximation of replacing the Poisson distribution of dark currents electrons y_{d}(μ_{d}) by a gaussian distribution, which allows to simulate all the dark noise created before amplification as a single gaussian random variable with a variance

$${σ}_{d}^{2}$$

which is the sum of

$${σ}_{pre}^{2}$$

and of the variance of y_{d}(μ_{d}). For the target sensor (Sony IMX249) we also need to consider a noise that takes the form of horizontal lines on the images. This leads us to break down the variance of the darn noise

$${σ}_{d}^{2}$$

into two terms:

$${σ}_{d}^{2} = {σ}_{d , pix}^{2} + {σ}_{d , line}^{2} , where {σ}_{d , line}^{2}$$

is the variance of the component of the dark noise that shows up as horizontal lines and

$${σ}_{d , pix}^{2}$$

the variance or the component of the dark noise that is spatially uncorrelated.

Noise Calibration. Following the parameterization introduced in the paragraph above and in Section 1.1, we need to calibrate the following noise parameters: σ_{d,pix}, σ_{d,line}, σₚₒₛₜ and g₁. The parameter g₁ is not a standard deviation but it characterizes the camera shot noise. We recall that g₁ is the gain from electrons to DN (digital numbers) at ISO 100 (i.e. when K=1), such that, in the general case, the gain g can be written g=g₁·K. The signal independent noise can be calibrated from a set of dark frame captures (raw images) taken at various gains. The variance of that noise can be written as

$${K}^{2} \cdot {g}_{1}^{2} \cdot {σ}_{d}^{2} + {σ}_{post}^{2} ,$$

such mat a regression against K² allows to estimate

$${g}_{1}^{2} \cdot {σ}_{d}^{2} and {σ}_{post}^{2} .$$

In the case of the target camera we find out that

$${σ}_{post}^{2}$$

is negligible. Then

$${g}_{1}^{2} \cdot {σ}_{d , line}^{2}$$

is estimated using the dark frames averaged along the rows. From

$${g}_{1}^{2} \cdot {σ}_{d}^{2} and {g}_{1}^{2} \cdot {σ}_{d , line}^{2}$$

we deduce

$${g}_{1}^{2} \cdot {σ}_{d , pix}^{2} .$$

### Once

$${g}_{1}^{2} \cdot {σ}_{d , pix}^{2} and {g}_{1}^{2} \cdot {σ}_{d , line}^{2}$$

have been calibrated, the gain g₁ is estimated from raw images of a set of pictures of a color checker chart, taken at various gains under a roughly uniform illumination. The temperature of the illuminant does not matter. The mean value of each patch pixel is estimated using a local polynomial estimator within the pixel's patch.

Noise Adaptation. The model is trained with images that contain noise distributed as the noise created by the target camera. The training dataset is composed of images taken with the Sony IMX490. As such they already contain noise produced by that sensor. Noise adaptation is performed during training from the source camera sensor (Sony IMX490) to the target camera sensor (Sony IMX249). This consists in adding just the right amount of noise to the image such that after noise adaptation the noise contained in the image matches the distribution of the noise of the target camera. The noise distributions of both the source and target camera need to be calibrated. The approach exposed above is used to achieve those calibrations, even though the induced noise model is only an approximation here. The images of the training set have been rescaled to match the definition of the target camera. For a given pixel in an (HDR) image of the training set, there is a mean number of photo-induced electrons μ_{p,source}. Suppose the exact same scene was taken with the target camera from the exact same point of view. Then for the corresponding pixel in the resulting raw image, there is a mean number of photo-induced electrons μ_{p,target}. It is assumed that μ_{p,source}=μ_{p,target} when the camera gain settings K=1 for the target camera. This can be realized in practice by adjusting the aperture and exposure time of the target camera given that the images of the training set have all been taken with the same fixed exposure settings. Those adjustments are based on the aperture and exposure time of the source camera, as well as the pixel sizes and the quantum efficiencies of both the source and target sensors. The assumption μ_{p,source}=μ_{p,target} implies that to simulate a raw image for the target camera from the source camera it is required to multiply the raw pixel value of the source camera by

$${g}_{source}^{- 1} \cdot {g}_{target} .$$

Here g_{source} and g_{target} are the quantities corresponding to the gain g introduced in Section 3, for the source and target cameras respectively. However the resulting simulated raw image still does not include noise adaptation for the dark noise.

To complete noise adaption the dark noise of the target camera is matched. Assuming

$${σ}_{d , source}^{2} and {σ}_{d , target}^{2}$$

are the variances of the dark noise for the source and the target cameras, a gaussian noise of variance

$${σ}_{sim}^{2}$$

is added to the pixel values, that is

$${σ}_{sim}^{2} = {g}_{target}^{2} \cdot ( {σ}_{d , target}^{2} - {σ}_{d , source}^{2} ) .$$

This is only possible if σ_{d,source}<σ_{d,target}, which is the case for the chosen source and target sensors. For the special case of a target sensor that includes a horizontal line noise as described above, both spatially uncorrelated and horizontal line noises with corresponding variances are added, computed as follows

$${σ}_{sim , pix}^{2} = {g}_{target}^{2} \cdot ( {σ}_{d , target}^{2} - {σ}_{d , pix}^{2} ) , {σ}_{sim , line}^{2} = {σ}_{d , line}^{2} .$$

Noise Augmentation. For the purpose of data augmentation, the method departs slightly from the way noise adaptation is outlined above. The strength of the simulated dark noise is randomly varied around the strength targeted by noise adaptation. More precisely, σₛᵢₘ is computed as

$${σ}_{sim} = max ( 0 , {g}_{target}^{2} \cdot ( {σ}_{d , target}^{2} \cdot {k}_{aug} - {σ}_{d , source}^{2} ) ) .$$

where log(k_{avg}) is sampled uniformly in [log(0.25), log(4)] and set to the same value for all the pixels of a given image pair example. In the case of a target sensor that includes a horizontal line noise, the noise augmentation is as follows.

$${σ}_{sim , pix}^{2} = {g}_{target}^{2} \cdot ( {σ}_{d , target}^{2} \cdot {k}_{avg} - {σ}_{d , pix}^{2} ) ,$$

$${σ}_{sim , line}^{2} = {σ}_{d , line}^{2} \cdot {k}_{avg} .$$

### 3.4 Network Training

During training, a single example is made of two consecutive frames (or not distant frames, closely following each other) forming a mini sequence along with bounding boxes and classes annotation for the second frame. The HDR training images 1 and 2 are shown in FIGS. 4A-1, 4A-2 and 4A-3 in boxes 2 and 4 respectively. The annotation of the HDR image 2 is represented with box 19 of FIGS. 4A-1, 4A-2 and 4A-3.

Training pipeline. The full end-to-end training pipeline of FIGS. 4A-1, 4A-2 and 4A-3 with learned AEC and object detection has the following six steps.

First, a 12 bit capture of the first frame with Simulated Raw Image 1 with a random exposure is simulated (FIGS. 4A-1, 4A-2 and 4A-3 box 3, FIG. 4B-1 box 1102). The random exposure e_{rand} is shifted from a base exposure e_{base} by a shift factor κ_{shift}, i.e. e_{rand}=κ_{shift}·e_{base}. The base exposure e_{base} is computed adaptively from the HDR frame pixel values as e_{base}=0.5·M_{white}·(γ·Ī_{ndr})⁻¹, with Ī_{ndr} the mean value of I_{ndr}. The logarithm of κ_{shift} is sampled uniformly in [log 0.1, log 10].

We then predict an exposure change with the proposed network using the given frame as input (FIGS. 4A-1, 4A-2 and 4A-3 boxes 9-18 of Global Image Feature Branch 27 and Semantic Branch 28, FIG. 4B-1 box 1103), and we simulate a 12 bit capture of the next frame with Simulated Raw Image 2 with this adjusted exposure (FIGS. 4A-1, 4A-2 and 4A-3 box 5, FIG. 4B-1 box 1104). The resulting Simulated raw image 2 frame is then processed by an ISP 6 first (FIGS. 4A-1, 4A-2 and 4A-3 box 6, FIG. 4B-1 box 1105).

The output RGB image of the ISP 6 is fed to a feature extractor, ResNet 7 (FIGS. 4A-1, 4A-2 and 4A-3 box 7, FIG. 4B-1 box 1105). From those features an object detector 8 predicts objects classes and bounding boxes (FIGS. 4A-1, 4A-2 and 4A-3 box 8, FIG. 4B-1 box 1105).

The entire imaging and detection pipeline is supervised with the object detector loss at the end (FIGS. 4A-1, 4A-2 and 4A-3 box 20, FIG. 4B-1 box 1106).

The rest of the modules/boxes in FIGS. 4A-1, 4A-2 and 4A-3 is similar to those of FIGS. 3A-1, 3A-2 and 3A-3, except the Training Stage(s) 100A, 200A, 300A being replaced with the Gradient Module 21. The two instances of ResNet 7 and the ISP instances 6, processing the Simulated Raw Image 1 and Image 2 respectively, share their weights.

Object Detector Loss. The object detector loss L_{OD} is the weighted sum of the region proposal network (RPN) loss, L_{RPN}, the second-stage loss, L_{SS}, and a penalty on the L² norm of the weights of the AE neural network, L_{penalty}. That is, the total loss is

$${L}_{OD} = {L}_{RPN} + {L}_{S S} + {λ}_{penalty} \cdot {L}_{penalty} .$$

Second Stage Loss. The second-stage loss L_{SS} is a sum of losses L_{RoI}, one for each of the regions of interest (RoI) output by the RPN. The loss L_{RoI} is defined as

$${L}_{RoI} ( p , u , {t}^{u} , v ) = {λ}_{SS , cls} {L}_{cls} ( p , u ) + {λ}_{SS , loc} [ u \geq 1 ] {L}_{loc} ( {t}^{u} , v ) .$$

The prior art describes a Fast R-CNN network having two sibling output layers. The first outputs encompass a discrete probability distribution (per RoI), p=(p₀, . . . , pₖ), over K+1 categories. As usual, p is computed by a softmax over the K+1 outputs of a fully connected layer. The second sibling layer outputs bounding-box regression offsets,

$${t}^{k} = ( {t}_{x}^{k} , {t}_{y}^{k} , {t}_{w}^{k} , {t}_{h}^{k} ) ,$$

for each of the K object classes, indexed by k. t^{k} is parameterized such that t^{k} specifies a scale-invariant translation and log-space height/width shift relative to an object proposal. Each training RoI is labeled with a ground-truth class u and a ground-truth bounding-box regression target v. A multi-task loss L_{RoI} is used on each labeled RoI to jointly train for classification and bounding-box regression, in which Lets (p, u)=−log pᵤ is log loss for true class u. The second task loss, L_{loc}, is defined over a tuple of true bounding-box regression targets for class u, v=(vₓ, y, v_{w}, vₕ), and a predicted tuple

$${t}^{u} = ( {t}_{x}^{u} , {t}_{y}^{u} , {t}_{w}^{u} , {t}_{h}^{u} ) ,$$

again for class u. The Iverson bracket indicator function [u≥1] evaluates to 1 when u≥1 and 0 otherwise. By convention the catch-all background class is labeled u=0.

For background Rols there is no notion of a ground-truth bounding box and hence L_{loc} is ignored. For bounding-box regression, we use the loss

$${L}_{l o c} ( {t}^{u} , v ) = {\sum }_{i ∈ \{ x , y , v , w , h \}} {smooth}_{{L}_{1}} ( {t}_{i}^{u} - {v}_{i} ) ,$$

in which

$${smooth}_{{L}_{1}} ( x ) = \{ \begin{matrix}0.5 {x}^{2} & if \vert x \vert < 1 \\ \vert x \vert - 0. 5 & otherwise\end{matrix}$$

is a robust L₁ loss.

RPN Loss. The RPN loss L_{RPN} is defined as:

$${L}_{RPN} ( \{ {p}_{i} \} , \{ {t}_{i} \} ) = {λ}_{RPN , cls} \frac{1}{{N}_{cls}} {\sum }_{i} {L}_{cls} ( {p}_{i} , {p}_{i}^{*} ) + {λ}_{RPN , reg} \frac{1}{{N}_{reg}} {\sum }_{i} {p}_{i}^{*} {L}_{reg} ( {t}_{i} , {t}_{i}^{*} ) .$$

Here, i is the index of an anchor in a mini-batch and pᵢ is the predicted probability of anchor i being an object. The ground-truth label

$${p}_{i}^{*}$$

is 1 if the anchor is positive, and is 0 if the anchor is negative. tᵢ is a vector representing the 4 parameterized coordinates of the predicted bounding box, and

$${t}_{i}^{*}$$

is that or the ground-truth pox associated with a positive anchor. The classification loss L_{cls} is log loss over two classes (object vs. not object). For the regression loss, we use

$${L}_{reg} ( {t}_{i} , {t}_{i}^{*} ) = R ( {t}_{i} - {t}_{i}^{*} )$$

where R is the robust loss function (smooth L₁) defined in Girshick et al. The term

$${p}_{i}^{*} {L}_{reg}$$

means the regression loss is activated only for positive anchors

$$( {p}_{i}^{*} = 1 )$$

and is disabled otherwise

$$( {p}_{i}^{*} = 0 ) .$$

All steps are implemented with TensorFlow graphs such that the auto-exposure network can be trained based on the object detector loss. The trainable parameters of the whole pipeline are updated (FIGS. 4A-1, 4A-2 and 4A-3 boxes 22-26, FIG. 4B-1 box 1108) following the stochastic gradient descent with momentum optimization algorithm. The gradient computation step appears in FIGS. 4A-1, 4A-2 and 4A-3 as box 21 and in FIG. 4B-1 as box 1107.

FIGS. 4B-1 and 4B2 illustrate the high-level operational flow-chart corresponding to the system diagrams of FIGS. 4A-1. 4A-2 and 4A3.

In the method 400 of FIG. 4B1, upon start (box 1100) first and second successive HDR images (HDR image 1 and HDR image 2), from two successive frames are retrieved (box 1101), followed by simulating a raw LDR image 1 from the respective HDR image 1 using a random exposure as described in detail above.

A predicted, improved exposure value for the raw LDR image 1 is computed using input from at least one of the Semantic Feature Branch 28 and/or the Global Image Feature Branch 27 (box 1103) as described in detail above.

Next, the predicted exposure value from box 1103 is used for simulating a raw LDR image 2 from the HDR image 2 (box 1104), followed by processing the raw LDR image 2 with the computer vision pipeline including the ISP 6, feature extractor Resnet 7 and objection detector 8 (box 1105).

Upon computing a training loss based on the ground truth of the processed image 2 (box 1106) and the gradient of the training loss with respect to the trainable parameters of the entire pipeline (box 1107), update the trainable parameters for the entire pipeline (box 1108).

If the maximum predetermined number of training steps has been reached (exit Yes from box 1109), the method 400 is terminated (box 1110). Otherwise (exit No from box 1109), the method returns back to the step 1001 for selecting another pair of successive HDR images and repeating the steps 1102-1109.

FIG. 4B-2 shows the step 1108 of FIG. 4B1 in more detail, namely indicating the update of weights and biases of the object detector neural network (box 1126), the updated of the weights and biases of ResNet 7 (box 1125), the update of the parameters of the ISP (box 1124), the update of the weights and biases of the semantic feature branch neural network (box 1123), and the update of the weights and biases of the global image feature branch neural network (box 1122).

Pretraining. The feature extractor has first been pretrained on ImageNet (ILSVRC2012). Then the object detector has been pretrained jointly with the ISP on several public and proprietary automotive data sets. This trained joint model (ISP+object detector) is reused as a starting point for the training of the two baselines and the two proposed models.

Learning Rate Schedule. For each of the two baselines and the two proposed models, the learning rate schedule is the same. The training is done for 20,000 steps with a learning rate 0.0003, then an additional 20,000 steps with a learning rate 0.0001 and finally 20,000 more steps with a learning rate 0.00003.

Training Hyperparameters. A batch size of 1 is used. The localization and objectness loss weights of the RPN are 4 and 3 (λ_{RPN, reg} and λ_{RPN, cls} respectively), the localization and classification loss weights of the second stage are 4 and 2 (λ_{SS,reg} and λ_{SS,cls} respectively). The number of proposals from the RPN is 300. A L₂ regularization is used for the weights of the auto-exposure neural network only, with weight λ_{penalty}=0.001

Two stage training for the hybrid model. The hybrid model is trained in two stages. We first train the semantic feature branch alone. Next, we add the global image feature branch to the network to make the full hybrid model and we repeat the training, following the same training procedure, including the same learning rate schedule.

However, it is understood that a different training mode may be also applied, for example, both global feature branch 27 and the semantic branch 28 may be trained jointly.

### 4. EVALUATION

### General Requirements

For training and evaluation of street objects are grouped into 6 categories, namely, Car/Van/SUV, Bus/Truck/Tram, Bike, Person, Traffic Sign, Traffic Lights. The Car/Van/SUV category is mainly for light to medium sized vehicles, while Bus/Truck/Tram includes medium to heavy duty vehicles, such as, construction vehicles. The Bike category includes bicycles, motorcycles and any other light transportation that have similar shape to a bicycle or motorcycle. Person category includes pedestrians, cyclists and their full extent is annotated. For groups of people, every individual is annotated separately. Traffic sign includes all standard traffic sign categories including electronic signs, and Traffic lights include lights for vehicles, public transports, pedestrians and cyclists. For all annotations only the visible extent of the objects are annotated as tightly as possible. Objects smaller than 5×5 pixels are ignored.

### Annotation Requirements for Live Evaluation Data

For live evaluation, captures were obtained by running two different auto exposure algorithms on a stereo pair. The main challenge while annotating these LDR images is that some of the regions can be either underexposed or overexposed. However, due to using two different algorithms, one of the two exposures are likely to have those regions properly exposed. To annotate these live evaluation data, a sequence of exposure pairs for annotation was used. The annotations for over and underexposed images were done by first trying to adjust the brightness and contrast of the images to maximize object visibility. If they are still not visible, the annotators chose the corresponding well exposed image and transferred the annotation to the badly exposed image while making sure that the annotations are spatially and temporally consistent. Each annotated sequence was checked for correctness by a quality controller and the annotations were adjusted as needed.

### 4.2 Synthetic Assessment

The proposed method is first evaluated by simulating scene intensity shifts using captured HDR data. To this end, a dataset of 400 pairs of consecutive HDR frames taken with the HDR Sony IMX490 sensor that was also used for capturing the training set, is used. Noise adaptation is applied, but no noise augmentation. For each pair of frame a random test exposure is simulated the same way as in the training pipeline except here K shift is sampled with equal probabilities in the set {k⁻¹, k}, with k=1.5 for mild shifts, k=4 for moderate shifts and k=10 for large shifts. The evaluation metric is the object detection average precision (AP) at 50% IOU over the 400 pairs and their horizontal flip. For each tested AEC method and each k∈{1.5,4, 10}, the experiments are repeated 12 times and the mean was computed, and the standard deviation of the AP score. For fair comparisons, the detector networks were fine-tuned separately for all auto-exposure baselines.

Quantitative and Qualitative Validation. The four AEC algorithms were compared, the proposed neural auto-exposure with histogram pyramid pooling only of FIG. 3A-1, the proposed neural auto-exposure with both histogram pyramid pooling and the semantic branch of FIG. 3A-3, an average-based AE algorithm of the prior art, and an AE algorithm of the prior art driven by local image gradients. The average-based AE employs an efficient, but fast scheme that adjusts the mean pixel value I mean of the current raw frame and adjusts the exposure by a factor 0.5·M_{white}/Iₘₑₐₙ. The gradient-based AE from Shim et al. aims to adjust exposure to maximize local image gradients. The proposed parameters, δ=0.06, and Kₚ=0.5 were used. Both baseline algorithms are implemented using TensorRT and runs in real-time on a Nvidia GTX 1070.

FIGS. 5A1, 5A2, 5A3, 5A4, 5A5, 5B1, 5B2, 5B3, 5B4, 5B5, 5C1, 5C2, 5C3, 5C4, 5C5, 5D1, 5D2, 5D3, 5D4 and 5D5 illustrate a comparison of the two proposed methods of the present invention and the two baselines of the prior art using simulations of mild (k=1.5) and moderate (k=4) exposure shifts. Namely, FIGS. 5A1, 5A2, 5A3, 5A4 and 5A5 show results for the prior art method of Average Auto-Exposure calculation for exposure shifts k=1.5, k=4, k=1.5, k=1.5 and k=4 respectively. FIGS. 5B1, 5B2, 5B3, 5B4 and 5B5 illustrate results for the prior art method of Gradient Auto-Exposure calculation for exposure shifts k=1.5, k=4, k=1.5, k=1.5 and k=4 respectively. FIGS. 5C1, 5C2, 5C, 5C4 and 5C5 illustrate results for the histogram method of the FIG. 3A-1 of the present invention for exposure shifts k=1.5, k=4, k=1.5, k=1.5 and k=4 respectively. And finally, FIGS. 5D1, 5D2, 5D3, 5D4 and 5D5 illustrate results for the hybrid method of the FIG. 3A-3 of the present invention for exposure shifts k=1.5, k=4, k=1.5, k=1.5 and k=4 respectively.

As can be seen from FIGS. 5C1, 5C2, 5C3, 5C4, 5C5 and 5D1, 5D2, 5D3, 5D4, 5D5 both methods of the present invention can recover from extreme exposures in cases where the prior art methods fail.

The last column of Table 3 lists the mean average precision (mAP) of all compared algorithms across automotive classes, including bike, bus and truck, car and van, person, traffic light, and traffic sign, for each of the three exposure shift scenarios. The other column of Table 3 list the corresponding individual AP scores. These synthetic results validate the proposed method as it outperforms the two baseline algorithms for each of the 6 classes and across all three exposure shift scenarios, with a larger margin for larger shifts. For large objects, such as buses or trams, which can alter the scene illumination substantially, the proposed semantic branch provides more than 14% margin in average precision, validating the proposed architecture.

Table 3 below shows the object detection performance, which is average precision at intersection over union 0.5 (AP at IoU 0.5) for three exposure shift simulation scenarios, for 6 classes and mean AP across classes (mAP). The base exposure is shifted by a factor randomly sampled in {0.667, 1.5} for small shifts, {0.25, 4} for moderate shifts and {0.1, 10} for large shifts. Results within one standard deviation of the corresponding best result are indicated with *.

TABLE 3
Object detection performance for three simulation scenarios

| | | Bus and | Car and | | Traffic | Traffic | |
|---|---|---|---|---|---|---|---|
| Method | Bike | Truck | Van | Person | Light | Sign | mAP |
| Gradient AE | 17.56 | 31.26 | 60.70* | 28.92 | 21.9 | 30.07 | 31.73 |
| Average AE | 16.01 | 29.74 | 59.56 | 28.85 | 21.53 | 29.7 | 30.9 |
| Histogram NN (ours) | 19.87* | 33.11 | 60.43 | 29.55 | 22.6 | 31.42 | 32.83 |
| Semantic NN (ours) | 20.19 | 34.15 | 60.87* | 30.21* | 23.35 | 30.87 | 33.27 |
| Hybrid NN (ours) | 20.18* | 37.06 | 61.07 | 30.6 | 23.98 | 31.18* | 34.01 |
| | Mild exposure shift k = 1.5 | | | | | | |
| Gradient AE | 17.02 | 25.47 | 57.27 | 24.93 | 20.87 | 27.95 | 28.92 |
| Average AE | 15.5 | 29.09 | 58.08 | 27.17 | 21.29 | 28.63 | 29.96 |
| Histogram NN (ours) | 19.8 | 33.99 | 60.32 | 29.41 | 22.69 | 31.34* | 32.92 |
| Semantic NN (ours) | 19.76 | 32.55 | 60.72* | 30.38* | 23.5 | 31.41 | 33.05 |
| Hybrid NN (ours) | 20.29 | 37.29 | 61.22 | 30.44 | 23.95 | 31.28* | 34.08 |
| | Moderate exposure shift k = 4 | | | | | | |
| Gradient AE | 13.22 | 19.81 | 48 | 18.61 | 16.18 | 21.62 | 22.91 |
| Average AE | 12.99 | 25.1 | 53.83 | 23.81 | 18.62 | 26.3 | 26.77 |
| Histogram NN (ours) | 18.32 | 32.06 | 60.39 | 28.44 | 22.7 | 31.12 | 32.17 |
| Semantic NN (ours) | 17.65 | 26.82 | 60.19 | 28.97 | 23.2 | 30.75 | 31.26 |
| Hybrid NN (ours) | 19.42 | 35.18 | 61.01 | 29.81 | 23.7 | 30.96* | 33.35 |

Large exposure shift k = 10

Comparison with Conventional HDR Detection Pipelines. In Table 4, results are provided of a synthetic comparison between object detection on the output of an HIDR ISP, the ARM Mali C71 which ingests an HDR RAW image, and the proposed method using an LDR image exposed using the proposed neural exposure control. In this synthetic experiment an additional HDR data set was used. This dataset is comprised of 6319 annotated images and was also taken with the Sony IMX490 sensor. The commercial ARM Mali C71 HDR ISP is run on the HDR raw images and run the pretrained object detector mentioned in Section 3.3 on the output of that ISP. The detector was fine-tuned on the post-ISP images from this HDR ISP. For comparison, a LDR capture is simulated from the previous frame HDR raw image and compute an exposure adjustment for the test frame (HDR raw image), from which a LDR capture is simulated that is processed with the trained pipeline (ISP+object detector). For this experiment, noise adaptation nor noise augmentation is applied, as the goal is to compare the use of HDR images with the use of LDR images auto-exposed with the proposed method, but not to validate the method for a specific target camera. It can be seen from Table 4 that the use of the joint model (trained AEC+ISP+detector) outperforms the traditional pipeline consisting of an HDR sensor followed by a conventional HDR ISP and an object detector trained on ISP-processed RGB images.

Table 4 below shows a synthetic comparison between a conventional HDR pipeline and LDR images auto-exposed with the proposed method. The reported scores are the average precision at IoU 0.5 for each of the 6 classes and the mean across classes. See text for additional details.

TABLE 4
Comparison of the object detection performances of a
conventional HDR pipeline and our method

| | Classes | | | | | | |
|---|---|---|---|---|---|---|---|
| | All | | Bus & | Car & | | Traffic | Traffic |
| Method | Classes | Bike | Truck | Van | Person | Light | Sign |
| CONVENTIONAL | 10.6 | 3.4 | 12.9 | 29.9 | 8.8 | 2.1 | 6.4 |
| HDR DETECTION | | | | | | | |
| PROPOSED LDR | 25.0 | 19.7 | 22.0 | 47.0 | 24.2 | 13.6 | 23.5 |
| HYBRID NN (ours) | | | | | | | |

### 4.3. Experimental Assessment

The proposed method is validated experimentally by implementing the proposed method and best baseline AEC algorithm from the simulation section on two separate camera prototype systems that are mounted side-by-side in a test-vehicle. The captured frames from the same automotive scenes, but different camera systems, are manually and separately annotated for fair comparison.

FIGS. 6B1, 6B2, 6B3, 6B4, 6B5 and 6B6 illustrate experimental prototype results of the proposed neural AEC of FIG. 3A-3 using the hybrid method of the present invention compared to the Average AE of the prior art method shown in FIGS. 6A1, 6A2, 6A3, 6A4, 6A5 and 6A6, using the real-time side-by-side prototype vehicle capture system shown in FIGS. 9A and 9B and FIGS. 10A, 10B, 10C and 10D. As can be seen from the FIGS. 6B1, 6B2, 6B3, 6B4, 6B5 and 6B6, the proposed hybrid method accurately balances exposure of objects still in the tunnel with exposure of objects outside of the tunnel and adapts itself robustly to changing conditions.

FIGS. 7A1 to 7H4 illustrate more experimental prototype results of the proposed neural AEC of FIG. 3A-3 using the hybrid method of the present invention compared to the Average AE of the prior art method, using the real-time side-by-side prototype vehicle capture system shown in FIGS. 9A and 9B and FIGS. 10A, 10B, 10C and 10D, where:

FIGS. 7A1, 7A2, 7A3 and 7A4 illustrate images of a first set of scenes captured using the Average AE;

FIGS. 7B1, 7B2, 7B3 and 7B4 illustrate corresponding images of the first set of scenes captured using the hybrid neural AEC of the present invention;

FIGS. 7C1, 7C2, 7C3 and 7C4 illustrate images of a second set of scenes captured using the Average AE;

FIGS. 7D1, 7D2, 7D3 and 7D4 illustrate corresponding images of the second set of scenes captured using the hybrid neural AEC of the present invention;

FIGS. 7E1, 7E2, 7E3 and 7E4 illustrate images of a third set of scenes captured using the Average AE;

FIGS. 7F1, 7F2, 7F3 and 7F4 illustrate corresponding images of the third set of scenes captured using the hybrid neural AEC of the present invention;

FIGS. 7G1, 7G2, 7G3 and 7G4 illustrate images of a fourth set of scenes captured using the Average AE; and

FIGS. 7H1, 7H2, 7H3 and 7H4 illustrate corresponding images of the fourth set of scenes captured using the hybrid neural AEC of the present invention.

As can be seen from FIGS. 7A1 to 7H4, the proposed method accurately balances exposure between objects and adapts itself robustly to changing conditions.

FIGS. 8A1, 8A2, 8A3 and 8A4 illustrate experimental prototype results of the Average AE baseline prior art method for a set of images/scenes, and FIGS. 8B1, 8B2, 8B3 and 8B4 illustrate experimental prototype results of the proposed hybrid neural AEC of FIG. 3A-3 for the same corresponding set of images/scenes, using the real-time side-by-side prototype vehicle capture system shown in FIGS. 9A and 9B and FIGS. 10A, 10B, 10C and 10D.

Similarly, FIGS. 8C1, 8C2, 8C3 and 8C4 illustrate experimental prototype results of the Average AE baseline prior art method for another set of images/scenes, and FIGS. 8D1, 8D2, 8D3 and 8D4 illustrate experimental prototype results of the proposed hybrid neural AEC of FIG. 3A-3 for the same corresponding another set of images/scenes, using the real-time side-by-side prototype vehicle capture system shown in FIGS. 9A and 9B and FIGS. 10A, 10B, 10C and 10D.

As can be seen from FIGS. 8B1, 8B2, 8B3, 8B4 and 8D1, 8D2, 8D3, 8D4, the proposed method of the embodiment of the present invention accurately balances exposure between objects and adapts itself robustly to changing conditions.

FIG. 9A illustrates an experimental capture setup for performing a side-by-side comparison of the hybrid method of FIGS. 3A-3 and 3B-3 and a prior art method based on average auto-exposure, for installation in an acquisition vehicle, and FIG. 9B illustrates the acquisition vehicle with the experimental capture setup of FIG. 9A.

FIGS. 10A, 10B, 10C and 10D illustrates the experimental capture setup of FIGS. 9A and 9B in more detail, namely FIGS. 10A, 10B show the experimental capture setup at different angles, FIG. 10C shows the experimental setup from the outside of the vehicle, and FIG. 10D provides an enlarged partial view of the vehicle with the experimental setup attached to the windshield.

Prototype Vehicle Setup. The object detection results of the proposed method are compared with the average AEC baseline method, which performed best in the previous synthetic assessment. Each of the two cameras is free-running and takes input image streams from separate imagers mounted side-by-side on the windshield of a vehicle, see FIGS. 9A and 9B. Images are recorded with the object detector and each AEC algorithm running live. For fair comparisons, the individually fine-tuned detectors for all auto-exposure baselines are used. All compared AEC methods and inference pipelines run in real-time on two separate machines, each equipped with a Nvidia GTX 1070 GPU.

The driving scenarios are highway and urban scenarios in European cities during the daytime. Several tunnels in the test set are included to also assess conditions of rapidly changing illumination. The route is taken two times during two successive days at the same time of the day. The input to the pair of compared algorithms are swapped between the two drives, such that the algorithm receiving input from the left camera the first day receives input from the right camera the second day and conversely. A total of 3140 frames is selected for testing each AE algorithm. Frames are selected in pairs, one from each algorithm, such that they match the sampling time. The selected test frames are annotated for the same six classes as mentioned above.

Quantitative and Qualitative Validation. All separately acquired images were manually annotated by humans for the automotive classes that the models were trained for. Using these ground-truth annotations, the detection performance of each pipeline is evaluated as shown in Table 5. These results confirm the improvement in object detection using the proposed model in both simulation and real-world experiments. As mentioned above, FIG. 6 show a qualitative comparison that further validate the proposed method in challenging high dynamic range conditions. Specifically, the method is capable of carefully balancing the exposure between dark and bright objects even in rapidly changing conditions.

Table 5 below shows experimental object detection evaluation for the proposed hybrid NN with the average-based AEC method running side-by-side in the prototype vehicle from FIGS. 9A and 9B. The reported scores are the average precision at IoU 0.5 for each of the 4 classes and the mean across classes.

TABLE 5
Experimental object detection evaluation of the proposed
hybrid NN and the average-based AE method running side-
by-side in the prototype vehicle

| | Classes | | | | |
|---|---|---|---|---|---|
| | All | | Bus & | Car & | |
| Method | Classes | Bike | Truck | Van | Person |
| AVERAGE AE | 28.80 | 11.93 | 28.92 | 54.20 | 20.17 |
| HYBRID NN (ours) | 32.37 | 13.96 | 34.09 | 58.90 | 22.53 |

### 5. CONCLUSIONS

Exposure control is critical for computer vision tasks as under or overexposure can lead to significant image degradations and signal loss. Existing HDR sensors and reconstruction pipelines approach this problem by aiming to acquire the full dynamic range of a scene with multiple captures of different exposures. This brute-force capture approach has the downside that these captures are challenging to merge for dynamic objects and sensor architectures suffer from reduced fill-factor. In the present invention, the use of low dynamic range (LDR) sensors has been proposed, paired with learned exposure control, as a computational alternative to the popular direction of HDR sensors. The present invention includes a neural exposure control that is optimized for downstream vision tasks and makes use of the scene semantics to choose optimal exposure parameters. To this end, an annotated HDR training dataset and a simulation based training approach that reduces the need for difficult to obtain large annotated LDR training data is introduced. The effectiveness of the approach in simulation and experimentally in a prototype vehicle system is validated, where the proposed neural auto-exposure outperforms conventional methods by more than 5 points in mean average precision.

Methods of the embodiment of the invention may be performed using one or more hardware processors, executing processor-executable instructions causing the hardware processors to implement the processes described above. Computer executable instructions may be stored in processor-readable storage media such as floppy disks, hard disks, optical disks, Flash ROMs (read only memories), non-volatile ROM, and RAM (random access memory). A variety of processors, such as microprocessors, digital signal processors, and gate arrays, may be employed.

Systems of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the methods of this disclosure.

It should be noted that methods and systems of the embodiments of the invention and data
described above are not, in any sense, abstract or intangible. Instead, the data is necessarily presented in a digital form and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems having processors on electronically or magnetically stored data, with the results of the data processing and data analysis digitally stored in one or more tangible, physical, data-storage devices and media.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

What is claimed is:

1. One or more non-transitory machine-readable storage media for determining at least one exposure value of a low dynamic range (LDR) sensor for use in high dynamic range (HDR) object detection of an autonomous vehicle, the one or more non-transitory machine-readable storage media comprising a plurality of instructions stored thereon that, in response to being executed, cause a system to:
form an auto-exposure neural network of an object detection system, the auto-exposure neural network configured to predict the at least one exposure value of the LDR sensor based on an LDR image acquired by the LDR sensor, the object detection system further including:
an image signal processing (ISP) pipeline; and
an object detection neural network, the ISP pipeline and the object detection neural network configured to provide the HDR object detection based on the LDR image and the at least one exposure value;
train the auto-exposure neural network jointly with at least one of (i) the ISP pipeline or (ii) the object detection neural network, thereby yielding a trained auto-exposure neural network; and
generate, using the trained auto-exposure neural network, at least one optimal exposure value of the LDR sensor to be used by the ISP and the object detection neural network in the HDR object detection.

2. The one or more non-transitory machine-readable storage media of claim 1, wherein the plurality of instructions further cause the system to:
form the auto-exposure neural network including a global image feature neural network configured to determine the at least one exposure value based on global image statistics of the LDR image.

3. The one or more non-transitory machine-readable storage media of claim 1, wherein the plurality of instructions further cause the system to:
form the auto-exposure neural network including a semantic feature neural network configured to determine the at least one exposure value based on scene semantics in the LDR image.

4. The one or more non-transitory machine-readable storage media of claim 1, wherein the plurality of instructions further cause the system to:
form the auto-exposure neural network including a global image feature neural network and a semantic feature neural network.

5. The one or more non-transitory machine-readable storage media of claim 1, wherein the plurality of instructions further cause the system to:
train the auto-exposure neural network by:
simulating a first simulated LDR image derived from a first HDR image;
inputting the first simulated LDR image with a random exposure shift into the auto-exposure neural network;
predicting, by the auto-exposure neural network, the at least one exposure value based on the input first simulated LDR image;
simulating a second simulated LDR image based on a second HDR image and the predicted at least one exposure value;
processing, by the ISP pipeline and the object detection neural network, the second simulated LDR image;
computing a training loss, based on the processed second simulated LDR image and ground truth annotated using the second HDR image; and
adjusting the auto-exposure neural network, based on the training loss.

6. The one or more non-transitory machine-readable storage media of claim 1, wherein the plurality of instructions further cause the system to:
train the auto-exposure neural network by:
simulating simulated LDR images derived from HDR images;
simulating noise of the LDR sensor based on the HDR images;
applying the simulated noise to the simulated LDR images; and
training the auto-exposure neural network using the applied simulated LDR images.

7. The one or more non-transitory machine-readable storage media of claim 1, wherein the plurality of instructions further cause the system to:
form the ISP pipeline, the ISP pipeline being differentiable.

8. The one or more non-transitory machine-readable storage media of claim 1, wherein the plurality of instructions further cause the system to:
form the ISP pipeline, structure of the ISP pipeline being independent from structure of the auto-exposure neural network.

9. A computer-implemented method for determining at least one exposure value of a low dynamic range (LDR) sensor for use in high dynamic range (HDR) object detection of an autonomous vehicle, the method comprising:
forming an auto-exposure neural network of an object detection system, the auto-exposure neural network configured to predict the at least one exposure value of the LDR sensor based on an LDR image acquired by the LDR sensor, the object detection system further including:
an image signal processing (ISP) pipeline; and
an object detection neural network, the ISP pipeline and the object detection neural network configured to provide the HDR object detection based on the LDR image and the at least one exposure value;
training the auto-exposure neural network jointly with at least one of (i) the ISP pipeline or (ii) the object detection neural network, thereby yielding a trained auto-exposure neural network; and
generating, using the trained auto-exposure neural network, at least one optimal exposure value of the LDR sensor to be used by the ISP and the object detection neural network in the HDR object detection.

10. The method of claim 9, further comprising training the auto-exposure neural network by:
simulating a first simulated LDR image derived from a first HDR image;
inputting the first simulated LDR image with a random exposure shift into the auto-exposure neural network;
predicting, by the auto-exposure neural network, the at least one exposure value based on the input first simulated LDR image;
simulating a second simulated LDR image based on a second HDR image and the predicted at least one exposure value;
processing, by the ISP pipeline and the object detection neural network, the second simulated LDR image;
computing a training loss, based on the processed second simulated LDR image and ground truth annotated using the second HDR image; and
adjusting the auto-exposure neural network, based on the training loss.

11. The method of claim 9, further comprising training the auto-exposure neural network by:
simulating simulated LDR images derived from HDR images;
simulating noise of the LDR sensor based on the HDR images;
applying the simulated noise to the simulated LDR images; and
training the auto-exposure neural network using the applied simulated LDR images.

12. The method of claim 9, further comprising forming the ISP pipeline, the ISP pipeline being differentiable.

13. A system of an autonomous vehicle for determining at least one auto-exposure value of a low dynamic range (LDR) sensor for use in high dynamic range (HDR) object detection of the autonomous vehicle, comprising at least one processor in communication with at least one memory device, the at least one processor programmed to:
form an auto-exposure neural network of an object detection system, the auto-exposure neural network configured to predict the at least one exposure value of the LDR sensor based on an LDR image acquired by the LDR sensor, the object detection system further including:
an image signal processing (ISP) pipeline; and
an object detection neural network, the ISP pipeline and the object detection neural network configured to provide the HDR object detection based on the LDR image and the at least one exposure value;
train the auto-exposure neural network jointly with at least one of (i) the ISP pipeline or (ii) the object detection neural network, thereby yielding a trained auto-exposure neural network; and
generate, using the trained auto-exposure neural network, at least one optimal exposure value of the LDR sensor to be used by the ISP and the object detection neural network in the HDR object detection.

14. The system of claim 13, wherein the at least one processor is further programmed to:
form the auto-exposure neural network including a global image feature neural network configured to determine the at least one exposure value based on global image statistics of the LDR image.

15. The system of claim 13, wherein the at least one processor is further programmed to:
form the auto-exposure neural network including a semantic feature neural network configured to determine the at least one exposure value based on scene semantics in the LDR image.

16. The system of claim 13, wherein the at least one processor is further programmed to:
form the auto-exposure neural network including a global image feature neural network and a semantic feature neural network.

17. The system of claim 13, wherein the at least one processor is further programmed to:
train the auto-exposure neural network by:
simulating a first simulated LDR image derived from a first HDR image;
inputting the first simulated LDR image with a random exposure shift into the auto-exposure neural network;
predicting, by the auto-exposure neural network, the at least one exposure value based on the input first simulated LDR image;
simulating a second simulated LDR image based on a second HDR image and the predicted at least one exposure value;
processing, by the ISP pipeline and the object detection neural network, the second simulated LDR image;
computing a training loss, based on the processed second simulated LDR image and ground truth annotated using the second HDR image; and
adjusting the auto-exposure neural network, based on the training loss.

18. The system of claim 13, wherein the at least one processor is further programmed to:
train the auto-exposure neural network by:
simulating simulated LDR images derived from HDR images;
simulating noise of the LDR sensor based on the HIDR images;
applying the simulated noise to the simulated LDR images; and
training the auto-exposure neural network using the applied simulated LDR images.

19. The system of claim 13, wherein the at least one processor is further programmed to:
form the ISP pipeline, the ISP pipeline being differentiable.

20. The system of claim 13, wherein the at least one processor is further programmed to:
form the ISP pipeline, structure of the ISP pipeline being independent from structure of the auto-exposure neural network.
